(19) United States
(12) Patent Application Publication
(10) Pub. No.: US 2025/0343694 A1
(43) Pub. Date: Nov. 6, 2025

(54) PROOF OF OWNERSHIP

(71) Applicant: nChain Licensing AG, Zug (CH)

(72) Inventors: Enrique LARRAIA, London (GB); Owen VAUGHAN, London (GB)

(21) Appl. No.: 18/880,113

(22) PCT Filed: Jun. 19, 2023
(86) PCT No.: PCT/EP2023/066486

§ 371 Date: Dec. 30, 2024

(30) Foreign Application Priority Data
Jun. 29, 2022 (GB) 2209495.7

(51) Int. Cl. H04L 9/32

(52) U.S. Cl. CPC H04L 9/3218; H04L 9/3271

(57) ABSTRACT

A computer-implemented method for proving sole ownership of a commitment key. The commitment key comprises two elements and a secret trapdoor value x defines a relationship between the elements of the commitment key. A challenge proof portion πᵢ is iteratively computed for a predefined number of iterations d, wherein the challenge proof portion is generated based on succinct commitments derived using the secret trapdoor value x. A challenge proof π is generated based on the challenge proof portions πᵢ. The challenge proof π is made available to a verifier. The challenge proof π is a non-interactive zero-knowledge proof proving knowledge of the secret trapdoor value x.

### CROSS REFERENCE TO RELATED APPLICATIONS

This application is the U.S. National Stage of International Application No. PCT/EP2023/066486 filed on Jun. 19, 2023, which claims the benefit of United Kingdom Patent Application No. 2209495.7, filed on Jun. 29, 2022, the contents of which are incorporated herein by reference in their entireties.

### TECHNICAL FIELD

The present disclosure relates to a computer implemented method for proving sole ownership and/or possession of a commitment key, and a computer-implemented method for verifying sole ownership and/or possession of the commitment key.

### BACKGROUND

A blockchain refers to a form of distributed data structure, wherein a duplicate copy of the blockchain is maintained at each of a plurality of nodes in a distributed peer-to-peer (P2P) network (referred to below as a “blockchain network”) and widely publicised. The blockchain comprises a chain of blocks of data, wherein each block comprises one or more transactions. Each transaction, other than so-called “coinbase transactions”, points back to a preceding transaction in a sequence which may span one or more blocks going back to one or more coinbase transactions. Coinbase transactions are discussed further below. Transactions that are submitted to the blockchain network are included in new blocks. New blocks are created by a process often referred to as “mining”, which involves each of a plurality of the nodes competing to perform “proof-of-work”, i.e. solving a cryptographic puzzle based on a representation of a defined set of ordered and validated pending transactions waiting to be included in a new block of the blockchain. It should be noted that the blockchain may be pruned at some nodes, and the publication of blocks can be achieved through the publication of mere block headers.

The transactions in the blockchain may be used for one or more of the following purposes: to convey a digital asset (i.e. a number of digital tokens), to order a set of entries in a virtualised ledger or registry, to receive and process timestamp entries, and/or to time-order index pointers. A blockchain can also be exploited in order to layer additional functionality on top of the blockchain. For example blockchain protocols may allow for storage of additional user data or indexes to data in a transaction. There is no pre-specified limit to the maximum data capacity that can be stored within a single transaction, and therefore increasingly more complex data can be incorporated. For instance this may be used to store an electronic document in the blockchain, or audio or video data.

Nodes of the blockchain network (which are often referred to as “miners”) perform a distributed transaction registration and verification process, which will be described in more detail later. In summary, during this process a node validates transactions and inserts them into a block template for which they attempt to identify a valid proof-of-work solution. Once a valid solution is found, a new block is propagated to other nodes of the network, thus enabling each node to record the new block on the blockchain. In order to have a transaction recorded in the blockchain, a user (e.g. a blockchain client application) sends the transaction to one of the nodes of the network to be propagated. Nodes which receive the transaction may race to find a proof-of-work solution incorporating the validated transaction into a new block. Each node is configured to enforce the same node protocol, which will include one or more conditions for a transaction to be valid. Invalid transactions will not be propagated nor incorporated into blocks. Assuming the transaction is validated and thereby accepted onto the blockchain, then the transaction (including any user data) will thus remain registered and indexed at each of the nodes in the blockchain network as an immutable public record.

The node who successfully solved the proof-of-work puzzle to create the latest block is typically rewarded with a new transaction called the “coinbase transaction” which distributes an amount of the digital asset, i.e. a number of tokens. The detection and rejection of invalid transactions is enforced by the actions of competing nodes who act as agents of the network and are incentivised to report and block malfeasance. The widespread publication of information allows users to continuously audit the performance of nodes. The publication of the mere block headers allows participants to ensure the ongoing integrity of the blockchain.

In an “output-based” model (sometimes referred to as a UTXO-based model), the data structure of a given transaction comprises one or more inputs and one or more outputs. Any spendable output comprises an element specifying an amount of the digital asset that is derivable from the proceeding sequence of transactions. The spendable output is sometimes referred to as a UTXO (“unspent transaction output”). The output may further comprise a locking script specifying a condition for the future redemption of the output. A locking script is a predicate defining the conditions necessary to validate and transfer digital tokens or assets. Each input of a transaction (other than a coinbase transaction) comprises a pointer (i.e. a reference) to such an output in a preceding transaction, and may further comprise an unlocking script for unlocking the locking script of the pointed-to output. So consider a pair of transactions, call them a first and a second transaction (or “target” transaction). The first transaction comprises at least one output specifying an amount of the digital asset, and comprising a locking script defining one or more conditions of unlocking the output. The second, target transaction comprises at least one input, comprising a pointer to the output of the first transaction, and an unlocking script for unlocking the output of the first transaction.

In such a model, when the second, target transaction is sent to the blockchain network to be propagated and recorded in the blockchain, one of the criteria for validity applied at each node will be that the unlocking script meets all of the one or more conditions defined in the locking script of the first transaction. Another will be that the output of the first transaction has not already been redeemed by another, earlier valid transaction. Any node that finds the target transaction invalid according to any of these conditions will not propagate it (as a valid transaction, but possibly to register an invalid transaction) nor include it in a new block to be recorded in the blockchain.

An alternative type of transaction model is an account-based model. In this case each transaction does not define the amount to be transferred by referring back to the UTXO of a preceding transaction in a sequence of past transactions, but rather by reference to an absolute account balance. The current state of all accounts is stored by the nodes separate to the blockchain and is updated constantly.

### SUMMARY

In the present disclosure, a data owner, or a party authorised by the data owner (e.g. a notary), has control over which third parties are able to be convinced that data owned by the data owner is correct. That is, the data owner can control who can verify the data.

In the methods disclosed herein, a verifier provides the data owner or notary with their commitment key, which is used to derive a commitment for the verifier. This “designated verifier commitment” can only be verified by the verifier providing the commitment key.

However, due to the nature of the commitment keys used, it is possible for multiple verifiers to have partial knowledge of the commitment key, such that each of the multiple verifiers could verify the data based on the verifier commitment value derived from said commitment key.

It is therefore desirable for a verifier to prove to the party computing the verifier commitment value that they are the sole owner and/or possessor of the commitment key, that is that the verifier providing the commitment key is the only party which is able to verify the data based on the provided key. In this way, a data owner or notary can be certain that only the verifier can verify the data.

According to one aspect disclosed herein, there is provided a computer-implemented method for proving sole ownership and/or possession of a commitment key, wherein the commitment key comprises two elements, wherein a secret trapdoor value x defines a relationship between the elements of the commitment key, the method comprising: iteratively computing a challenge proof portion πᵢ for a predefined number of iterations d, wherein the challenge proof portion is generated based on succinct commitments derived using the secret trapdoor value x; generating a challenge proof π based on the challenge proof portions πᵢ; and making the challenge proof π available to a verifier; wherein the challenge proof π is a non-interactive zero-knowledge proof proving knowledge of the secret trapdoor value x.

Aspects disclosed herein may be used, for example, in the following scenario. Alice (the data owner) enters a nightclub and Bob, the security guard at the door, asks her to prove that she is older than 18 years. She hands him her passport. After checking the passport Bob asks Alice if he can take a photocopy of it in case the Police comes to check that everyone inside the nightclub is not underage. Alice refuses because she does not want him to have (a certified proof of) her personal data. Instead, she says, the Police can come to her, and she will readily prove them that she is above 18. Thus, Alice wants to control who can be convinced of the fact that she is old enough.

Using the methods described herein, Alice can prove to Bob (a designated verifier) that her data has been obfuscated (committed and hashed) without giving Bob enough information to prove this to Charlie (a third party). Alice can control the link between the data m and the obfuscation by keeping a secret random value r that she used to commit to m. If she destroys r, the link between the obfuscation and the data is permanently destroyed also. The method disclosed herein involves a non-interactive zero-knowledge (nizk) proof of knowledge for designated verifiers to prove knowledge of the data owner's private value r. The proof π_{Bob} is specially crafted for Bob (the Designated Verifier) and he cannot use π_{Bob} to convince anyone else.

Furthermore, in contrast to general-purpose proof systems, the systems disclosed here do not require any trusted setup, it is fast and straightforward to implement.

Note that whilst the embodiments are primarily described in terms of a party (the data owner) proving ownership of the commitment key, the embodiments may equally be used to prove possession of the commitment key. In some examples, the commitment key may not necessarily belong to the data owner, with the data owner merely possessing the key. That is, possession of data does not necessarily mean ownership of the data, and vice versa. In these examples, the data owner may instead be referred to as a data possessor. It will be appreciated that the term “data owner” is merely used as an identifying label. In some examples, the data owner may both own and possess the key.

### BRIEF DESCRIPTION OF THE DRAWINGS

To assist understanding of embodiments of the present disclosure and to show how such embodiments may be put into effect, reference is made, by way of example only, to the accompanying drawings in which:

FIG. 1 is a schematic block diagram of a system for implementing a blockchain,

FIG. 2 schematically illustrates some examples of transactions which may be recorded in a blockchain,

FIG. 3 shows an example method for privately timestamping data,

FIG. 4 schematically illustrates data transfers between parties,

FIG. 5a shows an example method for notarising data,

FIG. 5b shows an example method for verifying notarised data,

FIG. 6 schematically illustrates notarisation of data by a trusted third party, and

FIG. 7 shows an example method for registering a commitment key with a notary.

### DETAILED DESCRIPTION OF EMBODIMENTS

### 1. Example System Overview

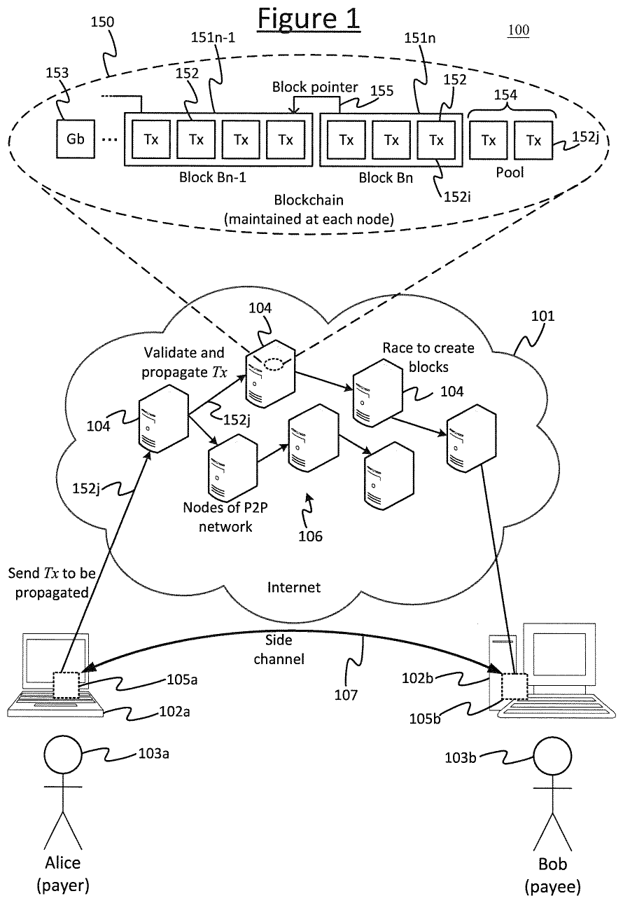

FIG. 1 shows an example system 100 for implementing a blockchain 150. The system 100 may comprise a packet-switched network 101, typically a wide-area internetwork such as the Internet. The packet-switched network 101 comprises a plurality of blockchain nodes 104 that may be arranged to form a peer-to-peer (P2P) network 106 within the packet-switched network 101. Whilst not illustrated, the blockchain nodes 104 may be arranged as a near-complete graph. Each blockchain node 104 is therefore highly connected to other blockchain nodes 104.

Each blockchain node 104 comprises computer equipment of a peer, with different ones of the nodes 104 belonging to different peers. Each blockchain node 104 comprises processing apparatus comprising one or more processors, e.g. one or more central processing units (CPUs), accelerator processors, application specific processors and/or field programmable gate arrays (FPGAs), and other equipment such as application specific integrated circuits (ASICs). Each node also comprises memory, i.e. computer-readable storage in the form of a non-transitory computer-readable medium or media. The memory may comprise one or more memory units employing one or more memory media, e.g. a magnetic medium such as a hard disk; an electronic medium such as a solid-state drive (SSD), flash memory or EEPROM; and/or an optical medium such as an optical disk drive.

The blockchain 150 comprises a chain of blocks of data 151, wherein a respective copy of the blockchain 150 is maintained at each of a plurality of blockchain nodes 104 in the distributed or blockchain network 106. As mentioned above, maintaining a copy of the blockchain 150 does not necessarily mean storing the blockchain 150 in full. Instead, the blockchain 150 may be pruned of data so long as each blockchain node 150 stores the block header (discussed below) of each block 151. Each block 151 in the chain comprises one or more transactions 152, wherein a transaction in this context refers to a kind of data structure. The nature of the data structure will depend on the type of transaction protocol used as part of a transaction model or scheme. A given blockchain will use one particular transaction protocol throughout. In one common type of transaction protocol, the data structure of each transaction 152 comprises at least one input and at least one output. Each output specifies an amount representing a quantity of a digital asset as property, an example of which is a user 103 to whom the output is cryptographically locked (requiring a signature or other solution of that user in order to be unlocked and thereby redeemed or spent). Each input points back to the output of a preceding transaction 152, thereby linking the transactions.

Each block 151 also comprises a block pointer 155 pointing back to the previously created block 151 in the chain so as to define a sequential order to the blocks 151. Each transaction 152 (other than a coinbase transaction) comprises a pointer back to a previous transaction so as to define an order to sequences of transactions (N.B. sequences of transactions 152 are allowed to branch). The chain of blocks 151 goes all the way back to a genesis block (Gb) 153 which was the first block in the chain. One or more original transactions 152 early on in the chain 150 pointed to the genesis block 153 rather than a preceding transaction.

Each of the blockchain nodes 104 is configured to forward transactions 152 to other blockchain nodes 104, and thereby cause transactions 152 to be propagated throughout the network 106. Each blockchain node 104 is configured to create blocks 151 and to store a respective copy of the same blockchain 150 in their respective memory. Each blockchain node 104 also maintains an ordered set (or “pool”) 154 of transactions 152 waiting to be incorporated into blocks 151. The ordered pool 154 is often referred to as a “mempool”. This term herein is not intended to limit to any particular blockchain, protocol or model. It refers to the ordered set of transactions which a node 104 has accepted as valid and for which the node 104 is obliged not to accept any other transactions attempting to spend the same output.

In a given present transaction 152j, the (or each) input comprises a pointer referencing the output of a preceding transaction 152i in the sequence of transactions, specifying that this output is to be redeemed or “spent” in the present transaction 152j. Spending or redeeming does not necessarily imply transfer of a financial asset, though that is certainly one common application. More generally spending could be described as consuming the output, or assigning it to one or more outputs in another, onward transaction. In general, the preceding transaction could be any transaction in the ordered set 154 or any block 151. The preceding transaction 152i need not necessarily exist at the time the present transaction 152j is created or even sent to the network 106, though the preceding transaction 152i will need to exist and be validated in order for the present transaction to be valid. Hence “preceding” herein refers to a predecessor in a logical sequence linked by pointers, not necessarily the time of creation or sending in a temporal sequence, and hence it does not necessarily exclude that the transactions 152i, 152j be created or sent out-of-order (see discussion below on orphan transactions). The preceding transaction 152i could equally be called the antecedent or predecessor transaction.

The input of the present transaction 152j also comprises the input authorisation, for example the signature of the user 103a to whom the output of the preceding transaction 152i is locked. In turn, the output of the present transaction 152j can be cryptographically locked to a new user or entity 103b. The present transaction 152j can thus transfer the amount defined in the input of the preceding transaction 152i to the new user or entity 103b as defined in the output of the present transaction 152j. In some cases a transaction 152 may have multiple outputs to split the input amount between multiple users or entities (one of whom could be the original user or entity 103a in order to give change). In some cases a transaction can also have multiple inputs to gather together the amounts from multiple outputs of one or more preceding transactions, and redistribute to one or more outputs of the current transaction.

According to an output-based transaction protocol such as bitcoin, when a party 103, such as an individual user or an organization, wishes to enact a new transaction 152j (either manually or by an automated process employed by the party), then the enacting party sends the new transaction from its computer terminal 102 to a recipient. The enacting party or the recipient will eventually send this transaction to one or more of the blockchain nodes 104 of the network 106 (which nowadays are typically servers or data centres, but could in principle be other user terminals). It is also not excluded that the party 103 enacting the new transaction 152j could send the transaction directly to one or more of the blockchain nodes 104 and, in some examples, not to the recipient. A blockchain node 104 that receives a transaction checks whether the transaction is valid according to a blockchain node protocol which is applied at each of the blockchain nodes 104. The blockchain node protocol typically requires the blockchain node 104 to check that a cryptographic signature in the new transaction 152j matches the expected signature, which depends on the previous transaction 152i in an ordered sequence of transactions 152. In such an output-based transaction protocol, this may comprise checking that the cryptographic signature or other authorisation of the party 103 included in the input of the new transaction 152j matches a condition defined in the output of the preceding transaction 152i which the new transaction spends (or “assigns”), wherein this condition typically comprises at least checking that the cryptographic signature or other authorisation in the input of the new transaction 152j unlocks the output of the previous transaction 152i to which the input of the new transaction is linked to. The condition may be at least partially defined by a script included in the output of the preceding transaction 152i. Alternatively it could simply be fixed by the blockchain node protocol alone, or it could be due to a combination of these. Either way, if the new transaction 152j is valid, the blockchain node 104 forwards it to one or more other blockchain nodes 104 in the blockchain network 106. These other blockchain nodes 104 apply the same test according to the same blockchain node protocol, and so forward the new transaction 152j on to one or more further nodes 104, and so forth. In this way the new transaction is propagated throughout the network of blockchain nodes 104.

In an output-based model, the definition of whether a given output (e.g. UTXO) is assigned (or “spent”) is whether it has yet been validly redeemed by the input of another, onward transaction 152j according to the blockchain node protocol. Another condition for a transaction to be valid is that the output of the preceding transaction 152i which it attempts to redeem has not already been redeemed by another transaction. Again if not valid, the transaction 152j will not be propagated (unless flagged as invalid and propagated for alerting) or recorded in the blockchain 150. This guards against double-spending whereby the transactor tries to assign the output of the same transaction more than once. An account-based model on the other hand guards against double-spending by maintaining an account balance. Because again there is a defined order of transactions, the account balance has a single defined state at any one time.

In addition to validating transactions, blockchain nodes 104 also race to be the first to create blocks of transactions in a process commonly referred to as mining, which is supported by “proof-of-work”. At a blockchain node 104, new transactions are added to an ordered pool 154 of valid transactions that have not yet appeared in a block 151 recorded on the blockchain 150. The blockchain nodes then race to assemble a new valid block 151 of transactions 152 from the ordered set of transactions 154 by attempting to solve a cryptographic puzzle. Typically this comprises searching for a “nonce” value such that when the nonce is concatenated with a representation of the ordered pool of pending transactions 154 and hashed, then the output of the hash meets a predetermined condition. E.g. the predetermined condition may be that the output of the hash has a certain predefined number of leading zeros. Note that this is just one particular type of proof-of-work puzzle, and other types are not excluded. A property of a hash function is that it has an unpredictable output with respect to its input. Therefore this search can only be performed by brute force, thus consuming a substantive amount of processing resource at each blockchain node 104 that is trying to solve the puzzle.

The first blockchain node 104 to solve the puzzle announces this to the network 106, providing the solution as proof which can then be easily checked by the other blockchain nodes 104 in the network (once given the solution to a hash it is straightforward to check that it causes the output of the hash to meet the condition). The first blockchain node 104 propagates a block to a threshold consensus of other nodes that accept the block and thus enforce the protocol rules. The ordered set of transactions 154 then becomes recorded as a new block 151 in the blockchain 150 by each of the blockchain nodes 104. A block pointer 155 is also assigned to the new block 151n pointing back to the previously created block 151n-1 in the chain. The significant amount of effort, for example in the form of hash, required to create a proof-of-work solution signals the intent of the first node 104 to follow the rules of the blockchain protocol. Such rules include not accepting a transaction as valid if it spends or assigns the same output as a previously validated transaction, otherwise known as double-spending. Once created, the block 151 cannot be modified since it is recognized and maintained at each of the blockchain nodes 104 in the blockchain network 106. The block pointer 155 also imposes a sequential order to the blocks 151. Since the transactions 152 are recorded in the ordered blocks at each blockchain node 104 in a network 106, this therefore provides an immutable public ledger of the transactions.

Note that different blockchain nodes 104 racing to solve the puzzle at any given time may be doing so based on different snapshots of the pool of yet-to-be published transactions 154 at any given time, depending on when they started searching for a solution or the order in which the transactions were received. Whoever solves their respective puzzle first defines which transactions 152 are included in the next new block 151n and in which order, and the current pool 154 of unpublished transactions is updated. The blockchain nodes 104 then continue to race to create a block from the newly-defined ordered pool of unpublished transactions 154, and so forth. A protocol also exists for resolving any “fork” that may arise, which is where two blockchain nodes 104 solve their puzzle within a very short time of one another such that a conflicting view of the blockchain gets propagated between nodes 104. In short, whichever prong of the fork grows the longest becomes the definitive blockchain 150. Note this should not affect the users or agents of the network as the same transactions will appear in both forks.

According to the bitcoin blockchain (and most other blockchains) a node that successfully constructs a new block 104 is granted the ability to newly assign an additional, accepted amount of the digital asset in a new special kind of transaction which distributes an additional defined quantity of the digital asset (as opposed to an inter-agent, or inter-user transaction which transfers an amount of the digital asset from one agent or user to another). This special type of transaction is usually referred to as a “coinbase transaction”, but may also be termed an “initiation transaction” or “generation transaction”. It typically forms the first transaction of the new block 151n. The proof-of-work signals the intent of the node that constructs the new block to follow the protocol rules allowing this special transaction to be redeemed later. The blockchain protocol rules may require a maturity period, for example 100 blocks, before this special transaction may be redeemed. Often a regular (non-generation) transaction 152 will also specify an additional transaction fee in one of its outputs, to further reward the blockchain node 104 that created the block 151n in which that transaction was published. This fee is normally referred to as the “transaction fee”, and is discussed blow.

Due to the resources involved in transaction validation and publication, typically at least each of the blockchain nodes 104 takes the form of a server comprising one or more physical server units, or even whole a data centre. However in principle any given blockchain node 104 could take the form of a user terminal or a group of user terminals networked together.

The memory of each blockchain node 104 stores software configured to run on the processing apparatus of the blockchain node 104 in order to perform its respective role or roles and handle transactions 152 in accordance with the blockchain node protocol. It will be understood that any action attributed herein to a blockchain node 104 may be performed by the software run on the processing apparatus of the respective computer equipment. The node software may be implemented in one or more applications at the application layer, or a lower layer such as the operating system layer or a protocol layer, or any combination of these.

Also connected to the network 101 is the computer equipment 102 of each of a plurality of parties 103 in the role of consuming users. These users may interact with the blockchain network 106 but do not participate in validating transactions or constructing blocks. Some of these users or agents 103 may act as senders and recipients in transactions. Other users may interact with the blockchain 150 without necessarily acting as senders or recipients. For instance, some parties may act as storage entities that store a copy of the blockchain 150 (e.g. having obtained a copy of the blockchain from a blockchain node 104).

Some or all of the parties 103 may be connected as part of a different network, e.g. a network overlaid on top of the blockchain network 106. Users of the blockchain network (often referred to as “clients”) may be said to be part of a system that includes the blockchain network 106; however, these users are not blockchain nodes 104 as they do not perform the roles required of the blockchain nodes. Instead, each party 103 may interact with the blockchain network 106 and thereby utilize the blockchain 150 by connecting to (i.e. communicating with) a blockchain node 106. Two parties 103 and their respective equipment 102 are shown for illustrative purposes: a first party 103a and his/her respective computer equipment 102a, and a second party 103b and his/her respective computer equipment 102b. It will be understood that many more such parties 103 and their respective computer equipment 102 may be present and participating in the system 100, but for convenience they are not illustrated. Each party 103 may be an individual or an organization. Purely by way of illustration the first party 103a is referred to herein as Alice and the second party 103b is referred to as Bob, but it will be appreciated that this is not limiting and any reference herein to Alice or Bob may be replaced with “first party” and “second “party” respectively.

The computer equipment 102 of each party 103 comprises respective processing apparatus comprising one or more processors, e.g. one or more CPUs, GPUs, other accelerator processors, application specific processors, and/or FPGAs. The computer equipment 102 of each party 103 further comprises memory, i.e. computer-readable storage in the form of a non-transitory computer-readable medium or media. This memory may comprise one or more memory units employing one or more memory media, e.g. a magnetic medium such as hard disk; an electronic medium such as an SSD, flash memory or EEPROM; and/or an optical medium such as an optical disc drive. The memory on the computer equipment 102 of each party 103 stores software comprising a respective instance of at least one client application 105 arranged to run on the processing apparatus. It will be understood that any action attributed herein to a given party 103 may be performed using the software run on the processing apparatus of the respective computer equipment 102. The computer equipment 102 of each party 103 comprises at least one user terminal, e.g. a desktop or laptop computer, a tablet, a smartphone, or a wearable device such as a smartwatch. The computer equipment 102 of a given party 103 may also comprise one or more other networked resources, such as cloud computing resources accessed via the user terminal.

The client application 105 may be initially provided to the computer equipment 102 of any given party 103 on suitable computer-readable storage medium or media, e.g. downloaded from a server, or provided on a removable storage device such as a removable SSD, flash memory key, removable EEPROM, removable magnetic disk drive, magnetic floppy disk or tape, optical disk such as a CD or DVD ROM, or a removable optical drive, etc.

The client application 105 comprises at least a “wallet” function. This has two main functionalities. One of these is to enable the respective party 103 to create, authorise (for example sign) and send transactions 152 to one or more bitcoin nodes 104 to then be propagated throughout the network of blockchain nodes 104 and thereby included in the blockchain 150. The other is to report back to the respective party the amount of the digital asset that he or she currently owns. In an output-based system, this second functionality comprises collating the amounts defined in the outputs of the various 152 transactions scattered throughout the blockchain 150 that belong to the party in question.

Note: whilst the various client functionality may be described as being integrated into a given client application 105, this is not necessarily limiting and instead any client functionality described herein may instead be implemented in a suite of two or more distinct applications, e.g. interfacing via an API, or one being a plug-in to the other. More generally the client functionality could be implemented at the application layer or a lower layer such as the operating system, or any combination of these. The following will be described in terms of a client application 105 but it will be appreciated that this is not limiting.

The instance of the client application or software 105 on each computer equipment 102 is operatively coupled to at least one of the blockchain nodes 104 of the network 106. This enables the wallet function of the client 105 to send transactions 152 to the network 106. The client 105 is also able to contact blockchain nodes 104 in order to query the blockchain 150 for any transactions of which the respective party 103 is the recipient (or indeed inspect other parties' transactions in the blockchain 150, since in embodiments the blockchain 150 is a public facility which provides trust in transactions in part through its public visibility). The wallet function on each computer equipment 102 is configured to formulate and send transactions 152 according to a transaction protocol. As set out above, each blockchain node 104 runs software configured to validate transactions 152 according to the blockchain node protocol, and to forward transactions 152 in order to propagate them throughout the blockchain network 106. The transaction protocol and the node protocol correspond to one another, and a given transaction protocol goes with a given node protocol, together implementing a given transaction model. The same transaction protocol is used for all transactions 152 in the blockchain 150. The same node protocol is used by all the nodes 104 in the network 106.

When a given party 103, say Alice, wishes to send a new transaction 152j to be included in the blockchain 150, then she formulates the new transaction in accordance with the relevant transaction protocol (using the wallet function in her client application 105). She then sends the transaction 152 from the client application 105 to one or more blockchain nodes 104 to which she is connected. E.g. this could be the blockchain node 104 that is best connected to Alice's computer 102. When any given blockchain node 104 receives a new transaction 152j, it handles it in accordance with the blockchain node protocol and its respective role. This comprises first checking whether the newly received transaction 152j meets a certain condition for being “valid”, examples of which will be discussed in more detail shortly. In some transaction protocols, the condition for validation may be configurable on a per-transaction basis by scripts included in the transactions 152. Alternatively the condition could simply be a built-in feature of the node protocol, or be defined by a combination of the script and the node protocol.

On condition that the newly received transaction 152j passes the test for being deemed valid (i.e. on condition that it is “validated”), any blockchain node 104 that receives the transaction 152j will add the new validated transaction 152 to the ordered set of transactions 154 maintained at that blockchain node 104. Further, any blockchain node 104 that receives the transaction 152j will propagate the validated transaction 152 onward to one or more other blockchain nodes 104 in the network 106. Since each blockchain node 104 applies the same protocol, then assuming the transaction 152j is valid, this means it will soon be propagated throughout the whole network 106.

Once admitted to the ordered pool of pending transactions 154 maintained at a given blockchain node 104, that blockchain node 104 will start competing to solve the proof-of-work puzzle on the latest version of their respective pool of 154 including the new transaction 152 (recall that other blockchain nodes 104 may be trying to solve the puzzle based on a different pool of transactions 154, but whoever gets there first will define the set of transactions that are included in the latest block 151. Eventually a blockchain node 104 will solve the puzzle for a part of the ordered pool 154 which includes Alice's transaction 152j). Once the proof-of-work has been done for the pool 154 including the new transaction 152j, it immutably becomes part of one of the blocks 151 in the blockchain 150. Each transaction 152 comprises a pointer back to an earlier transaction, so the order of the transactions is also immutably recorded.

Different blockchain nodes 104 may receive different instances of a given transaction first and therefore have conflicting views of which instance is ‘valid’ before one instance is published in a new block 151, at which point all blockchain nodes 104 agree that the published instance is the only valid instance. If a blockchain node 104 accepts one instance as valid, and then discovers that a second instance has been recorded in the blockchain 150 then that blockchain node 104 must accept this and will discard (i.e. treat as invalid) the instance which it had initially accepted (i.e. the one that has not been published in a block 151).

An alternative type of transaction protocol operated by some blockchain networks may be referred to as an “account-based” protocol, as part of an account-based transaction model. In the account-based case, each transaction does not define the amount to be transferred by referring back to the UTXO of a preceding transaction in a sequence of past transactions, but rather by reference to an absolute account balance. The current state of all accounts is stored, by the nodes of that network, separate to the blockchain and is updated constantly. In such a system, transactions are ordered using a running transaction tally of the account (also called the “position”). This value is signed by the sender as part of their cryptographic signature and is hashed as part of the transaction reference calculation. In addition, an optional data field may also be signed the transaction. This data field may point back to a previous transaction, for example if the previous transaction ID is included in the data field.

### 2. UTXO-Based Model

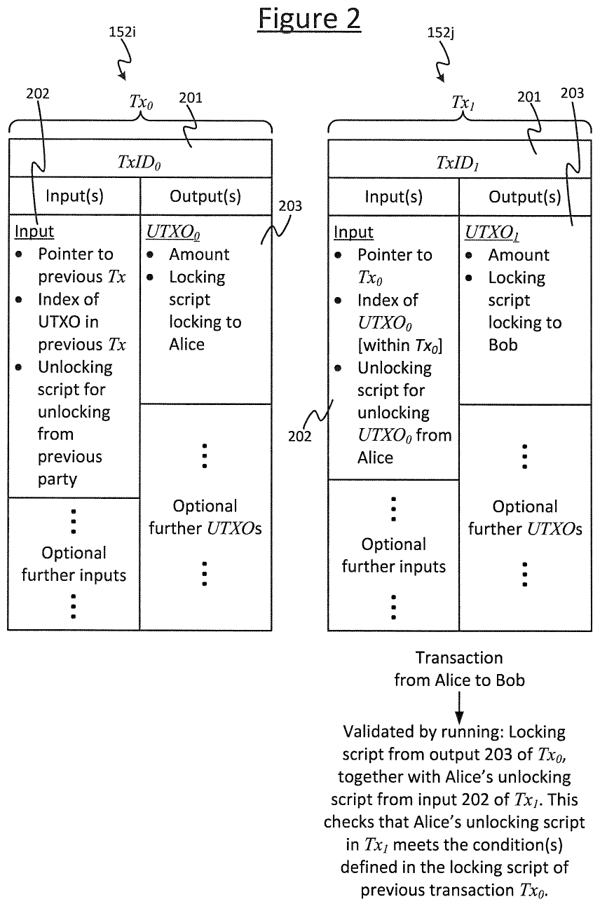

FIG. 2 illustrates an example transaction protocol. This is an example of a UTXO-based protocol. A transaction 152 (abbreviated “Tx”) is the fundamental data structure of the blockchain 150 (each block 151 comprising one or more transactions 152). The following will be described by reference to an output-based or “UTXO” based protocol. However, this is not limiting to all possible embodiments. Note that while the example UTXO-based protocol is described with reference to bitcoin, it may equally be implemented on other example blockchain networks.

In a UTXO-based model, each transaction (“Tx”) 152 comprises a data structure comprising one or more inputs 202, and one or more outputs 203. Each output 203 may comprise an unspent transaction output (UTXO), which can be used as the source for the input 202 of another new transaction (if the UTXO has not already been redeemed). The UTXO includes a value specifying an amount of a digital asset. This represents a set number of tokens on the distributed ledger. The UTXO may also contain the transaction ID of the transaction from which it came, amongst other information. The transaction data structure may also comprise a header 201, which may comprise an indicator of the size of the input field(s) 202 and output field(s) 203. The header 201 may also include an ID of the transaction. In embodiments the transaction ID is the hash of the transaction data (excluding the transaction ID itself) and stored in the header 201 of the raw transaction 152 submitted to the nodes 104.

Say Alice 103a wishes to create a transaction 152j transferring an amount of the digital asset in question to Bob 103b. In FIG. 2 Alice's new transaction 152j is labelled “Tx₁”. It takes an amount of the digital asset that is locked to Alice in the output 203 of a preceding transaction 152i in the sequence, and transfers at least some of this to Bob. The preceding transaction 152i is labelled “Tx₀” in FIG. 2. Tx₀ and Tx₁ are just arbitrary labels. They do not necessarily mean that Tx₀ is the first transaction in the blockchain 151, nor that Tx₁ is the immediate next transaction in the pool 154. Tx₁ could point back to any preceding (i.e. antecedent) transaction that still has an unspent output 203 locked to Alice.

The preceding transaction Tx₀ may already have been validated and included in a block 151 of the blockchain 150 at the time when Alice creates her new transaction Tx₁, or at least by the time she sends it to the network 106. It may already have been included in one of the blocks 151 at that time, or it may be still waiting in the ordered set 154 in which case it will soon be included in a new block 151. Alternatively Tx₀ and Tx₁ could be created and sent to the network 106 together, or Tx₀ could even be sent after Tx₁ if the node protocol allows for buffering “orphan” transactions. The terms “preceding” and “subsequent” as used herein in the context of the sequence of transactions refer to the order of the transactions in the sequence as defined by the transaction pointers specified in the transactions (which transaction points back to which other transaction, and so forth). They could equally be replaced with “predecessor” and “successor”, or “antecedent” and “descendant”, “parent” and “child”, or such like. It does not necessarily imply an order in which they are created, sent to the network 106, or arrive at any given blockchain node 104. Nevertheless, a subsequent transaction (the descendent transaction or “child”) which points to a preceding transaction (the antecedent transaction or “parent”) will not be validated until and unless the parent transaction is validated. A child that arrives at a blockchain node 104 before its parent is considered an orphan. It may be discarded or buffered for a certain time to wait for the parent, depending on the node protocol and/or node behaviour.

One of the one or more outputs 203 of the preceding transaction Tx₀ comprises a particular UTXO, labelled here UTXO₀. Each UTXO comprises a value specifying an amount of the digital asset represented by the UTXO, and a locking script which defines a condition which must be met by an unlocking script in the input 202 of a subsequent transaction in order for the subsequent transaction to be validated, and therefore for the UTXO to be successfully redeemed. Typically the locking script locks the amount to a particular party (the beneficiary of the transaction in which it is included). I.e. the locking script defines an unlocking condition, typically comprising a condition that the unlocking script in the input of the subsequent transaction comprises the cryptographic signature of the party to whom the preceding transaction is locked.

The locking script (aka scriptPubKey) is a piece of code written in the domain specific language recognized by the node protocol. A particular example of such a language is called “Script” (capital S) which is used by the blockchain network. The locking script specifies what information is required to spend a transaction output 203, for example the requirement of Alice's signature. Unlocking scripts appear in the outputs of transactions. The unlocking script (aka scriptSig) is a piece of code written the domain specific language that provides the information required to satisfy the locking script criteria. For example, it may contain Bob's signature. Unlocking scripts appear in the input 202 of transactions.

So in the example illustrated, UTXO₀ in the output 203 of Tx₀ comprises a locking script [Checksig P_{A}] which requires a signature Sig P_{A} of Alice in order for UTXO₀ to be redeemed (strictly, in order for a subsequent transaction attempting to redeem UTXO₀ to be valid). [Checksig P_{A}] contains a representation (i.e. a hash) of the public key P_{A} from a public-private key pair of Alice. The input 202 of Tx₁ comprises a pointer pointing back to Tx₁ (e.g. by means of its transaction ID, TxID₀, which in embodiments is the hash of the whole transaction Tx₀). The input 202 of Tx₁ comprises an index identifying UTXO₀ within Tx₀, to identify it amongst any other possible outputs of Tx₀. The input 202 of Tx₁ further comprises an unlocking script <Sig P_{A}> which comprises a cryptographic signature of Alice, created by Alice applying her private key from the key pair to a predefined portion of data (sometimes called the “message” in cryptography). The data (or “message”) that needs to be signed by Alice to provide a valid signature may be defined by the locking script, or by the node protocol, or by a combination of these.

When the new transaction Tx₁ arrives at a blockchain node 104, the node applies the node protocol. This comprises running the locking script and unlocking script together to check whether the unlocking script meets the condition defined in the locking script (where this condition may comprise one or more criteria). In embodiments this involves concatenating the two scripts:

$$< Sig {P}_{A} > < {P}_{A} > \vert \vert [ Checksig {P}_{A} ]$$

where “∥” represents a concatenation and “< . . . >” means place the data on the stack, and “[ . . . ]” is a function comprised by the locking script (in this example a stack-based language).

Equivalently the scripts may be run one after the other, with a common stack, rather than concatenating the scripts. Either way, when run together, the scripts use the public key P_{A} of Alice, as included in the locking script in the output of Tx₀, to authenticate that the unlocking script in the input of Tx₁ contains the signature of Alice signing the expected portion of data. The expected portion of data itself (the “message”) also needs to be included in order to perform this authentication. In embodiments the signed data comprises the whole of Tx₁ (so a separate element does not need to be included specifying the signed portion of data in the clear, as it is already inherently present).

The details of authentication by public-private cryptography will be familiar to a person skilled in the art. Basically, if Alice has signed a message using her private key, then given Alice's public key and the message in the clear, another entity such as a node 104 is able to authenticate that the message must have been signed by Alice. Signing typically comprises hashing the message, signing the hash, and tagging this onto the message as a signature, thus enabling any holder of the public key to authenticate the signature. Note therefore that any reference herein to signing a particular piece of data or part of a transaction, or such like, can in embodiments mean signing a hash of that piece of data or part of the transaction.

If the unlocking script in Tx₁ meets the one or more conditions specified in the locking script of Tx₀ (so in the example shown, if Alice's signature is provided in Tx₁ and authenticated), then the blockchain node 104 deems Tx₁ valid. This means that the blockchain node 104 will add Tx₁ to the ordered pool of pending transactions 154. The blockchain node 104 will also forward the transaction Tx₁ to one or more other blockchain nodes 104 in the network 106, so that it will be propagated throughout the network 106. Once Tx₁ has been validated and included in the blockchain 150, this defines UTXO₀ from Tx₀ as spent. Note that Tx₁ can only be valid if it spends an unspent transaction output 203. If it attempts to spend an output that has already been spent by another transaction 152, then Tx₁ will be invalid even if all the other conditions are met. Hence the blockchain node 104 also needs to check whether the referenced UTXO in the preceding transaction Tx₀ is already spent (i.e. whether it has already formed a valid input to another valid transaction). This is one reason why it is important for the blockchain 150 to impose a defined order on the transactions 152. In practice a given blockchain node 104 may maintain a separate database marking which UTXOs 203 in which transactions 152 have been spent, but ultimately what defines whether a UTXO has been spent is whether it has already formed a valid input to another valid transaction in the blockchain 150.

If the total amount specified in all the outputs 203 of a given transaction 152 is greater than the total amount pointed to by all its inputs 202, this is another basis for invalidity in most transaction models. Therefore such transactions will not be propagated nor included in a block 151.

Note that in UTXO-based transaction models, a given UTXO needs to be spent as a whole. It cannot “leave behind” a fraction of the amount defined in the UTXO as spent while another fraction is spent. However the amount from the UTXO can be split between multiple outputs of the next transaction. E.g. the amount defined in UTXO₀ in Tx₀ can be split between multiple UTXOs in Tx₁. Hence if Alice does not want to give Bob all of the amount defined in UTXO₀, she can use the remainder to give herself change in a second output of Tx₁, or pay another party.

In practice Alice will also usually need to include a fee for the bitcoin node 104 that successfully includes her transaction 104 in a block 151. If Alice does not include such a fee, Tx₀ may be rejected by the blockchain nodes 104, and hence although technically valid, may not be propagated and included in the blockchain 150 (the node protocol does not force blockchain nodes 104 to accept transactions 152 if they don't want). In some protocols, the transaction fee does not require its own separate output 203 (i.e. does not need a separate UTXO). Instead any difference between the total amount pointed to by the input(s) 202 and the total amount of specified in the output(s) 203 of a given transaction 152 is automatically given to the blockchain node 104 publishing the transaction. E.g. say a pointer to UTXO₀ is the only input to Tx₁, and Tx₁ has only one output UTXO. If the amount of the digital asset specified in UTXO₀ is greater than the amount specified in UTXO₁, then the difference may be assigned (or spent) by the node 104 that wins the proof-of-work race to create the block containing UTXO₁. Alternatively or additionally however, it is not necessarily excluded that a transaction fee could be specified explicitly in its own one of the UTXOs 203 of the transaction 152.

Alice and Bob's digital assets consist of the UTXOs locked to them in any transactions 152 anywhere in the blockchain 150. Hence typically, the assets of a given party 103 are scattered throughout the UTXOs of various transactions 152 throughout the blockchain 150. There is no one number stored anywhere in the blockchain 150 that defines the total balance of a given party 103. It is the role of the wallet function in the client application 105 to collate together the values of all the various UTXOs which are locked to the respective party and have not yet been spent in another onward transaction. It can do this by querying the copy of the blockchain 150 as stored at any of the bitcoin nodes 104.

Note that the script code is often represented schematically (i.e. not using the exact language). For example, one may use operation codes (opcodes) to represent a particular function. “OP_. . . ” refers to a particular opcode of the Script language. As an example, OP_RETURN is an opcode of the Script language that when preceded by OP_FALSE at the beginning of a locking script creates an unspendable output of a transaction that can store data within the transaction, and thereby record the data immutably in the blockchain 150. E.g. the data could comprise a document which it is desired to store in the blockchain.

Typically an input of a transaction contains a digital signature corresponding to a public key P_{A}. In embodiments this is based on the ECDSA using the elliptic curve secp256k1. A digital signature signs a particular piece of data. In some embodiments, for a given transaction the signature will sign part of the transaction input, and some or all of the transaction outputs. The particular parts of the outputs it signs depends on the SIGHASH flag. The SIGHASH flag is usually a 4-byte code included at the end of a signature to select which outputs are signed (and thus fixed at the time of signing).

The locking script is sometimes called “scriptPubKey” referring to the fact that it typically comprises the public key of the party to whom the respective transaction is locked. The unlocking script is sometimes called “scriptSig” referring to the fact that it typically supplies the corresponding signature. However, more generally it is not essential in all applications of a blockchain 150 that the condition for a UTXO to be redeemed comprises authenticating a signature. More generally the scripting language could be used to define any one or more conditions. Hence the more general terms “locking script” and “unlocking script” may be preferred.

### 3. Side Channel

As shown in FIG. 1, the client application on each of Alice and Bob's computer equipment 102a, 120b, respectively, may comprise additional communication functionality. This additional functionality enables Alice 103a to establish a separate side channel 107 with Bob 103b (at the instigation of either party or a third party). The side channel 107 enables exchange of data separately from the blockchain network. Such communication is sometimes referred to as “off-chain” communication. For instance this may be used to exchange a transaction 152 between Alice and Bob without the transaction (yet) being registered onto the blockchain network 106 or making its way onto the chain 150, until one of the parties chooses to broadcast it to the network 106. Sharing a transaction in this way is sometimes referred to as sharing a “transaction template”. A transaction template may lack one or more inputs and/or outputs that are required in order to form a complete transaction. Alternatively or additionally, the side channel 107 may be used to exchange any other transaction related data, such as keys, negotiated amounts or terms, data content, etc.

The side channel 107 may be established via the same packet-switched network 101 as the blockchain network 106. Alternatively or additionally, the side channel 301 may be established via a different network such as a mobile cellular network, or a local area network such as a local wireless network, or even a direct wired or wireless link between Alice and Bob's devices 102a, 102b. Generally, the side channel 107 as referred to anywhere herein may comprise any one or more links via one or more networking technologies or communication media for exchanging data “off-chain”, i.e. separately from the blockchain network 106. Where more than one link is used, then the bundle or collection of off-chain links as a whole may be referred to as the side channel 107. Note therefore that if it is said that Alice and Bob exchange certain pieces of information or data, or such like, over the side channel 107, then this does not necessarily imply all these pieces of data have to be send over exactly the same link or even the same type of network.

### 4. Zero-Knowledge Proofs

Let [symbol] ₚ be a finite group of prime order p, and let [symbol] ₚ be the field of exponents. Elements in [symbol] ₚ are denoted with small roman letters x∈ [symbol] ₚ, and elements in [symbol] ₚ with capital roman letters G∈ [symbol] ₚ. Vectors of n elements in

$${ℤ}_{p}^{n}$$

are denoted in bold x. Likewise, vectors of m elements in

$${𝔾}_{p}^{m}$$

are denoted as G.

The symbol “+” is used herein for both the group operation of [symbol] ₚ (in additive notation) and for the addition operation in the field [symbol] ₚ (mod p addition). Scalar multiplication is denoted as x·G For practical instantiations we set [symbol] ₚ to be an elliptic curve.

### 4.1 Sigma Protocols

Let [symbol] be an NP-relation. That is, a subset of {0,1}*×{0,1}* such that (st,w)∈ [symbol] can be checked in polynomial time in the length of st, and the length of w is also polynomial in the length of st.

The first element of the tuple is called the statement and it is public information. The second element is called the witness (to the statement) and it is private. There might be more than one witness for a given statement. The induced NP-language [symbol] is the set of statements.

$${ℒ}_{R} := \{ st : ∃ w such that ( st , w ) ∈ ℛ \} .$$

A sigma protocol is a three-round protocol between a prover and a verifier. Both parties receive as input the statement st. Additionally, the prover receives the witness w as an auxiliary input and the verifier may receive any arbitrary auxiliary input. The prover proves knowledge of the witness w by providing a challenge solution w, otherwise referred to herein as a public transcript, to the verifier, who verifies the challenge solution TC based on the protocol.

The sigma protocol may be implemented using the following steps:
1. The prover computes a commitment A using randomness a. It then sends A to the verifier while it keeps a secret.
2. The verifier randomly samples a challenge e and sends it to the prover
3. The prover computes an answer z (using w and a) and sends it to the verifier.
4. The verifier based on the public transcript π:=(A,e,z) accepts the statement st as valid or not.

A sigma protocol has the following properties.

Completeness. If (st, w)∈ [symbol] then the verifier accepts with probability one.

Special soundness. For any pair of accepting transcripts π=(A,e,z), π′=(A, e′, z′) that have the same commitment A (first message of the prover) and distinct challenges e≠e′, it is possible to compute a witness w, such that (st, w)∈ [symbol] .

Special honest verifier zero-knowledge (SHVZK). There exists a polynomial-time algorithm Sim which on input st∈ [symbol] and random e, it outputs accepting transcripts π=(A,e,z) indistinguishable from the protocol's transcripts

Special soundness implies a stronger property: sigma protocols are also proof of knowledge (of a witness).

Also, SHVZK implies the standard notion of (honest-verifier) zero-knowledge, where a simulator is tasked with simulating transcripts on receiving only the statement as input. In other words, SHVZK guarantees that no information about the witness is leaked from the exchanged messages assuming the verifier behaves as prescribed.

### 4.1.1 An Example: Schnorr Protocol

Given two group elements G, H∈ [symbol] ₚ, the Schnorr protocol proves knowledge of the discrete logarithm x:=d log_{G} (H)∈ [symbol] ₚ. The steps are:
1. The prover samples a∈ [symbol] ₚ at random and computes A:=a·G. It sends A to the verifier.
2. The verifier randomly samples a challenge e∈ [symbol] ⊆ [symbol] ₚ and sends it to the prover.
3. The prover computes z:=a+ex mod p and sends it to the verifier.
4. The verifier accepts if and only if z·G=A+e·H.

It is easy to see that the Schnorr protocol is complete and SHVZK. To see why it has special soundness, observe that from two accepting transcripts (A,e,z), (A, e′, z′) with different challenges e≠e′ we can write z·G=A+e·H and z′·G=A+e′·H. Subtracting the second equation from the first one (note same A is used in both), we obtain (z−z′)·G=(e−e′)·H. Thus, we conclude that

$${dlog}_{G} ( H ) = \frac{z - z}{e - {e}^{′}} .$$

Observe that since e≠e′ then e−e′ has (multiplicative) in [symbol] ₚ inverse and it can be computed efficiently, so we can compute the discrete logarithm using the two challenges and the two answers.

### 4.1.2 Removing Interactions—The Fiat-Shamir Heuristic

Sigma protocols are examples of public-coin interactive proof systems. That is, the message sent by the verifier (the challenge) is random and independent from the prover's messages. Exploiting this feature, an interactive sigma protocol can be turned non-interactive (just one message from prover to verifier) by emulating the verifier's entropy used to sample the challenge e with a cryptographic hash function. This is known as the Fiat-Shamir heuristic.

The Fiat-Shamir heuristic operates in a stronger security model. Therein, a cryptographic hash function is modelled as a function that on fresh input bitstrings it outputs uniformly distributed bitstrings. In this security model, well-known hash functions, like SHA256, can be used to construct a ‘random oracle’ function RO: {0,1}*→ [symbol] that maps arbitrary bitstrings to the space of challenges [symbol] . Now the rover can compute e without the help of the verifier, simply setting e:=RO(ctxt∥st∥Ā). Observe that tr:=ctxt∥st∥Ā is the (public) transcript occurring right after the challenge e is generated by the verifier in the interactive sigma protocol. Here ctxt denotes (public) context information, such as session or party identifiers, known to both parties in advance.

The assumption on the RO function ensures two things. First, the challenge e is randomly distributed, and therefore, the interactive protocol only needs to satisfy zero-knowledge against honest verifiers (or SHVZK). Second, the prover is unable to calculate the challenge before calculating the commitment A (and the statement st for that matter), so the order of execution of the protocol cannot be inverted.

The latest is true provided the challenge space [symbol] is large enough so that trying with different commitments Ā does not ever hit the (unique) challenge that would allow simulation. A medium/conservative choice is to use challenges of size 80 or 128 bits respectively, however it will be appreciated that other challenge bit sizes may be used.

### 4.2 Pedersen Commitments

Vector Pedersen commitments, or batch Pedersen commitments, is a generalization of Pedersen scheme to commit to a vector x∈

$${ℤ}_{p}^{n}$$

using a single group element C∈ [symbol] ₚ. Batch Pedersen can be instantiated over any group where the discrete logarithm assumption is hard.

The scheme has two algorithms. A description of the group [symbol] ₚ is assumed to be an implicit input to both algorithms.
Commit Com(m, r, CK): On input message vector m=(m₁, . . . mₙ)∈

$${ℤ}_{p}^{n} ,$$

a random element r∈ [symbol] ₚ and a commitment key CK:=(G₁ . . . Gₙ, H)∈

$${ℤ}_{p}^{n} ,$$

output point:

$$C = {m}_{1} \cdot {G}_{1} + … + {m}_{n} \cdot {G}_{n} + r \cdot H$$

Verify commit VerifyCom(m, r, C, CK): On input opening (m,r)∈

$${ℤ}_{p}^{n} \times {ℤ}_{p}$$

a commitment C∈ [symbol] ₚ and a commitment key CK∈n+1 compute C*=Com(x, CK; r). If C*=C output b=T (accept). Else output b=1 (reject).

Each G₁ . . . Gₙ, H is a point on the elliptical curve, such that a commitment key for n=1 is a pair of points on the elliptical curve. The Pedersen commitments provide a way in which n different messages can be committed to by a single elliptical curve.

### 4.2.1 Verifiable Generation of the Commitment Key

The group element H is to be generated in a secure way such that no relationship between the exponents of points Gᵢ and H is known. Correct generation can be verified publicly.

### 4.2.2 Trapdoor Commitment Key

The group element H is generated picking exponents x₁, . . . , xₙ and setting H:=x₁·G₁+ . . . +xₙ·Gₙ. Note that, with the knowledge of x:=(x₁, . . . , xₙ), Pedersen commitments are not binding anymore. For example, for case n=1, suppose H=x·G, and that C=m·G+r·H. It is possible to open a commitment C to an arbitrary value m′≠m setting r′:=r+x⁻¹(m−m′) mod p. The value x may be referred to herein as a trapdoor or a trapdoor value.

4.3 Zero-Knowledge Arguments with Designated Verifier

Let [symbol] be an NP-language that admits a sigma protocol. There is a framework in which a [symbol] prover Alice 130a is able to prove the statement st∈ [symbol] only to a designated verifier Bob 103b (who is in possession of a secret, or trapdoor, x), and no one else. The argument is non-interactive, and the conviction is non-transferable. The latter means that Bob 103b is not able to convince a third (hidden) verifier Charlie 103c about the veracity of the statement, even if Charlie 103c is given the secret x.

Alice 103a generates a proof πᵥ to prove the statement:

$$st ∈ {ℒ}_{ℛ} or {}^{″} I know secret {x}^{″} .$$

The proof πᵥ is crafted specially for Bob 103b. If Bob is confident that his secret x has not been compromised, then n_{y}v is indeed a convincing proof to himself. However, Bob is unable to convince Charlie 103c that st∈ [symbol] , using πᵥ or x, because the very same proof could have been generated by Bob 103b (proving that he knows x).

A trapdoor commitment scheme (such as Pedersen with non-verifiable commitment keys—see Section 4.1) can be used, where the trapdoor x is known to the designated verifier (Bob 103b). The prover (Alice 103a) commits to a random value w in a commitment C, and use C, (along with the statement and the first message A of the sigma protocol) to generate ‘half’ of the challenge with the hash function. The non-interactive challenge is defined as:

$$e := h + w where h := Hash ( st ‖ C ‖ A ) .$$

The designated verifier Bob, besides the checks of the sigma protocol, also checks that C opens to w. Now, since Bob can open C to any value he likes (using the trapdoor x—see Section 5.1), he can fake proofs πᵥ running a simulator Sim on a random challenge e to obtain π:=(A,e,z) and then open commitment C to w*:=e −Hash(st∥c∥A).

### 5. The Proof System

This section specifies the proof scheme that allows a Data Owner to control who can be convinced of the link between their data and a hashed commitment of the data. This embodiment comprises a non-interactive proof system that Alice (the Prover) uses to convince Bob (the Designated Verifier) of the knowledge of the private value r used to commit to data m.

### 5.1 the Statement

The Data Owner commits to her data m in a hiding way using a Pedersen commitment key CK_{DO}:=(G_{DO},H_{DO}). The public statement (known at least to the Data Owner and the Designated Verifier) is the tuple:

$$st := ( m , C , {CK}_{DO} , obf ) ∈ {ℤ}_{p} \times {𝔾}_{p}^{3} \times {\{ 0 , 1 \}}^{256}$$

The data is encoded as an element m∈ [symbol] ₚ. The Data Owner generates a designated verifier nizk proof of knowledge to prove knowledge of elements in the following set:

$$ZKP ( st ) := \{ r ∈ {ℤ}_{p} : C = m \cdot {G}_{DO} + r \cdot {H}_{DO} ∧ obfDat = SHA 256 ( C ) \}$$

### 5.2 Generating and Storing the Commitment Key

The commitment key CK_{DO} can be shared across multiple Data Owners, but it must be generated in a verifiable way that ensures x:=DLOG_{G}_{_{DO}}(H_{DO}) is not known to anyone (see Section 4.1). To make this key publicly available, it may be stored as OP_RETURN data it in the blockchain.

### 5.3 Prover and Designated Verifier Algorithms

For a given statement st as defined above, the Data Owner generates a nizk argument π_{DV} to prove they know an opening r∈ZKP(st), without revealing r to the verifier. In other words, they prove knowledge of DLOG_{H}_{_{DO}}(C−m′·G_{DO})).

The Designated Verifier chooses a random secret trapdoor x∈ [symbol] ₚ and sets up a new commitment key as CK_{DV}:=(G_{DV}, H_{DV}:=xG_{DV}). In this section we assume the Data Owner knows CK_{DV} when generating π_{DV}.

The algorithms, given below, use a cryptographic hash function Hash: {0,1}*→ [symbol] ₚ to generate non-interactive challenges.

| Prover: | Verifier: |
|---|---|
| Inputs: | Inputs: |
| • Statement st := (m, C, CK_{DO}, obf) ∈ | • Statement st := (m, C, CK_{DO}, obf) ∈ |
| ${ℤ}_{p} \times {𝔾}_{p}^{3} \times {\{ 0 , 1 \}}^{256}$ | ${ℤ}_{p} \times {𝔾}_{p}^{3} \times {\{ 0 , 1 \}}^{256}$ |
| • Witness: r ∈ [symbol] ₚ s.t. C = m · G_{DO} + r · | • Nizk proof π_{DV} := (D, A, z, w, s) ∈ |
| H_{DO} | ${𝔾}_{p}^{2} \times {ℤ}_{p}^{3}$ |
| • Context information: | • Context information: |
| $ctxt := ( sid \vert \vert id , {CK}_{DV} ) ∈ {\{ 0 , 1 \}}^{*} \times {𝔾}_{p}^{2}$ | $( ctxt := ( sid \vert \vert id , m , {CK}_{DV} ) ∈ {\{ 0 , 1 \}}^{*} \times {𝔾}_{p}^{2}$ |
| Steps: | Steps: |
| 1. a ← [symbol] ₚ, A ← a · H_{DO} | 1. If D ≠ w · G_{DV} + s · H_{DV} reject. |
| 2. w, s ← [symbol] ₚ, D ← w · G_{DV} + s · H_{DV} // | 2. h ← Hash(ctxt, st, A, D) |
| EC point addition | 3. e ← h + w mod p |
| 3. h ← Hash(ctxt, st, A, D) | 4. If z · H_{DO} ≠ A + e · (C − m · G_{DO}) reject. |
| 4. e ← h + w mod p // [symbol] ₚ addition | 5. If obfDat ≠ SHA256(C) reject. Else accept. |
| 5. Z ← a + er mod p | Output: Accept/reject |
| 6. π_{DV} ← (D, A, z, w, s) | |
| $Outpu \text{t:} {π}_{DV} ∈ {𝔾}_{p}^{2} \times {ℤ}_{p}^{3}$ | |

### 5.4 Faking Proofs

The Designated Verifier is able to generate “fake proofs” which are valid for a fake statement comprising a fake data value m′. A third party receiving the fake proof would be satisfied that the fake proof satisfies the verification algorithm, however, could not be satisfied that the Data Owner, and not the Designated Verifier, were the source of the data.

Let a tuple st:=(m, C, CK_{DO}, obf) such that obf=SHA256(C). The Designated Verifier, armed with the knowledge of the trapdoor x can generate valid proofs for any data m even if they do not know an opening r∈ZKP(st). This is possible because the Designated Verifier can open commitments under their key CK_{DV} to any value they like, and therefore choose in advance the challenge of the Schnorr proof (that purportedly proves knowledge of DLOG_{H}_{_{DO}}(C−m′·G_{DO})). The algorithm to fake proofs is detailed below.

Fake proof:

Inputs:
• $Statement st := ( m , C , {CK}_{DO} , obf ) ∈ {ℤ}_{p} \times {𝔾}_{p}^{3} \times {\{ 0 , 1 \}}^{256} // Honestly generated . It$
holds obf = Hash(C)
• m′ ∈ [symbol] ₚ// Any data (possibly different than m)
• Trapdoor: x ∈ [symbol] ₚ s.t. H_{DV} = X · G_{DV}
• $Context informatio \text{n:} ctxt := ( sid \vert \vert id , {CK}_{DV} ) ∈ {\{ 0 , 1 \}}^{*} \times {𝔾}_{p}^{4}$
Steps:
1. z, e ← [symbol] ₚ, A ← z · H_{DO} − e · (C − m′ · G_{DO})
2. d ← [symbol] ₚ, D ← d · G_{DV}
3. h ← Hash(ctxt, st, A, D)
4. w ← e − h mod p
$5. s ← \frac{d - e + h}{x} mod p // Compute opening with trapdoor$
6. π_{DV} ← (D, A, z, w, s)
$Outpu \text{t:} {π}_{DV} ∈ {𝔾}_{p}^{2} \times {ℤ}_{p}^{3} // Valid proof for fake statement st := ( {m}^{′} , C , obfDat )$

Thus, a third party receiving a proof π from the Designated Verifier cannot verify the source of the data, and more specifically cannot prove that the Data Owner is the source of the data.

### 6. Private Timestamps

The first application of the proof system described in Section 5 is to timestamp data in a private manner. The Data Owner obfuscates the data m, and the obfuscation obfDat is uploaded to the blockchain. That is, the Data Owner uploads to the blockchain an obfuscated data commitment obfDat:=SHA256(C), where C=Com(m, r, CK_{DO}), while keeping the randomness r private. More generally, the obfuscation obfDat can be any hash of the data commitment value C. That is, obfDat:=Hash′(C), where Hash′ is a cryptographic hash function, and is not necessarily SHA256 or the hash function used to generate challenges e.

Later she proves (only) to a Designated Verifier the link between obfDat and the data m without revealing the private value r. The proof ensures timestamp of m towards the Designated Verifier; the obfuscation and non-transferability of the proof ensures privacy to everyone but the Designated Verifier.

The data is logged in the blockchain to ensure its immutability and existence at a given time. However, due to the hiding property of Pedersen commitments no one can infer which data has been timestamped.

It will be appreciated that storing the obfuscation on the blockchain results in the data being logged implicitly. That is, the data m need not be stored on the blockchain.

### 6.1 Proving Correct Timestamping

Once obfData appears in the Blockchain, any person that wants to verify its link to the data can act as the Designated Verifier. They will be convinced that indeed m is consistent with obfDat.

The steps to prove and verify correct timestamping are as follows:
1. The Designated Verifier generates a trapdoor commitment key CK_{DV}:=(G,H)∈

$${𝔾}_{p}^{2} .$$

Recall the trapdoor is x∈ [symbol] ₚ such that H=x·G. It sends CK_{DV} to the Data Owner.
2. The Data Owner runs algorithm Prove from the previous section on inputs (m, C, CK_{DO}, obf), r and CK_{DV}. It sends (m, C, π_{DV}) to the Designated Verifier
3. The Designated Verifier runs algorithm Verify on inputs (m, C, π_{DV}). If the output is accepting, he deems the data m correct.

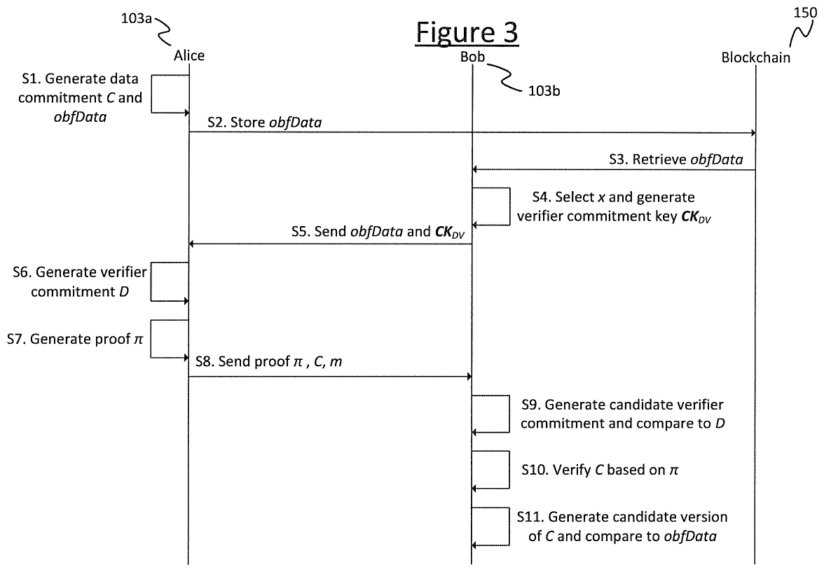

FIG. 3 shows an example method for implementing the prover and verifier algorithms set out above. In this example, Alice 103a is the prover and data owner, while Bob 103b is the designated verifier.

At step 1, Alice 103a generates, using the data m, a data commitment value C, where C=Com(m, r, CK_{DO}), r is a secret value known only to Alice 103a, and CK_{DO} is a data owner commitment key, i.e. Alice's commitment key. Alice 103a hashes the data commitment value to generate the obfuscated data value obfData.

Alice 103a stores the obfuscation data value obfData to the blockchain 150 in a proof blockchain transaction, step 2. The OP_RETURN script is used to render these values available to Bob 103b and other users. In some embodiments, the commitment value C is also stored to the blockchain 150.

Bob 103b retrieves the obfuscation data value obfData from the blockchain at step 4. He selects the trapdoor value x and uses this to generate a designated verifier commitment key CK_{DV}, where CK_{DV}:=(G_{DV}, H_{DV}:=xG_{DV}), step 4. Bob 103b sends his designated verifier commitment key CK_{DV} to Alice 103a at step 5, together with the obfuscation data value obfData. This message acts as, or includes, a request for the proof T for proving ownership of the data m.

Once Alice 103a has received the designated verifier commitment key CK_{DV}, she generates the verifier commitment value D using the designated verifier commitment key CK_{DV}, such that D=w·G_{DV}+s·H_{DV}, step 6. In this step, Alice 103a is committing to a random value w using CK_{DV}. This random value w is later used to form the challenge e=h+w, but w cannot be chosen based on h because Alice 103a commits to m first, that is the commitment D is used to generate h to ensure Alice 103a commits to w first.

At step 7, Alice 103a generates the proof π for proving knowledge of the secret value r. Alice 103a uses the obfuscation data value obfData received from Bob 103b to identify which data m Bob 103b has requested a proof of ownership for, and thus which secret value r to use when generating the proof w. Alice 103a may maintain a lookup table with entries (m, r, C, obfData) for implementing this step.

Alice 103a then sends the proof w, which includes the verifier commitment value D, to Bob 103b at step 8, and thereby decommits to the random value w. Alice 103a also send the commitment value C and the data m to Bob 103b.

Bob 103b generates a target verifier commitment value using w·G_{DV}+s·H_{DV}, which he compares to the verifier commitment value D at step 9. If these values match, Bob 103b verifies the data commitment value C based on the proof π by implementing steps 2 to 4 of the Verify algorithm set out in 5.2 above. In this step, Bob is checking the decommitment (w,s) is correct for commitment D, where w is a committed message and s is an opening. He uses his commitment key CK_{DV} for this.

Bob 103b, at step 11, generates a candidate obfuscation data value by hashing the data commitment value C, which he compares to the retrieved, or “target”, obfuscation data value obfData. The obfuscation data value obfData retrieved from the blockchain may be referred to as a target obfuscation data value obfData.

If Bob 103b is satisfied by the comparisons performed at steps 9, 10, and 11, Bob 103b can be assured that Alice 103a is the owner of data m.

### 6.2 Privacy of the Timestamps Via Non-Transferable Proofs

After receiving (m, C, π_{DV}) with obfDat=SHA256(C) from the Data Owner (Alice 103a), the Designated Verifier (Bob 103b) can produce for any data m*≠m of his choice a convincing proof π*_{DV}, that is, a proof that passes the verification algorithm, running algorithm Fake proof described in section 5.4 above. With such power, a third party (Charlie 103c) cannot ever be sure if the data that Bob 103b forwards comes from the Data Owner or from the Designated Verifier himself.

Put differently, Charlie 103c cannot tell whether the data was created before uploading obfDat to the blockchain (by Alice 103a) or afterwards (when Bob 103b sees the commitment C). This means that any data coming from Bob 103b is not bounded to the timestamp obfDat, maintaining the privacy of m to anyone that is not Bob 103b.

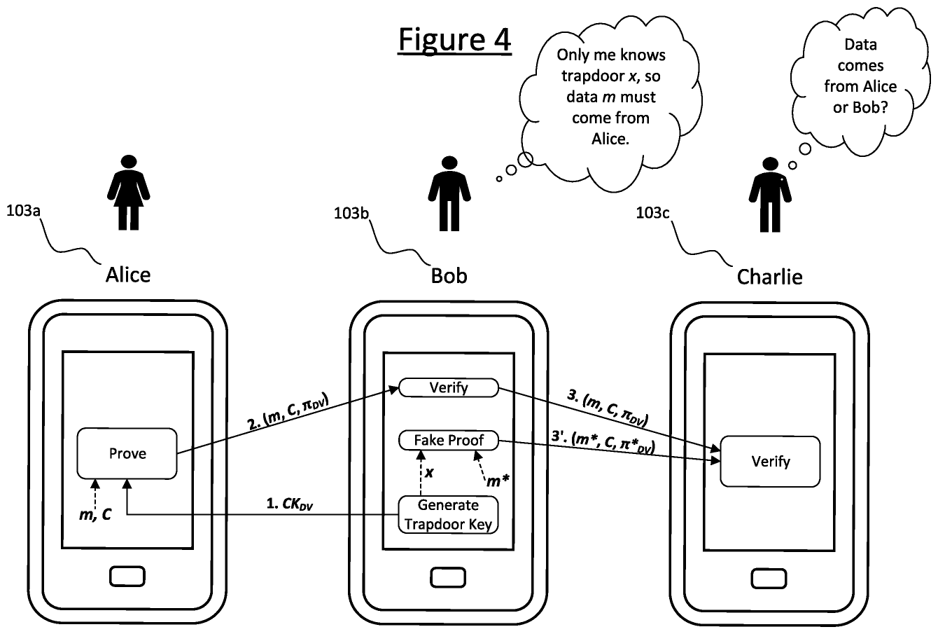

FIG. 4 provides an illustration of the information which may be provided to Charlie 103c which may pass the verification algorithm.

### 7. Self-Sovereign Notarisation of Data

The Proof and Verify algorithms set out above can be used in a method for providing notarised data.

In a self-sovereign notarisation of data implementation, the Data Owner takes an active role in the process of notarisation (whereby the data is signed by the Notary) and uploading the signed data to the blockchain.

The Notary receives the data m but signs the obfuscation obfDat. The Data Owner is empowered with (a) strong privacy: no one can link the signature (stored on-chain) back to the actual data, and (b) control of who verifies the signature: only the Designated Verifier (who is convinced of the existence of such link by virtue of the proof) can conclude, by verifying the signature, that the Notary (implicitly) signed the data.

There is provided a two-phase protocol between the Data Owner, the Designated Verifier, and the Notary. The parameters params of the scheme are preconfigured and already stored in the blockchain. They consist in the verification key PK of the Notary for signatures as well as the commitment key CK_{DO} of the Data Owners.

Phase 1: Notarisation of data. In the first phase, the Data Owner commits to their data m and sends it along with the commitment C to the Notary, who signs a hash of the commitment. The Data Owner subsequently stores the obfuscated and signed data Data*:=(obfDat,σ) in the blockchain, where obfDat=SHA256(C).

Phase 2: Verification of notarised data. In the second phase, a Designated Verifier retrieves Data* from the blockchain and requests the data m and the commitment C to the Data Owner along with a non-interactive zero-knowledge proof π_{DV} of knowledge of the opening r used to generate C from m. The Designated Verifier checks the proof using the Proof and the signature σ, and also that obfDat is the hash of C.

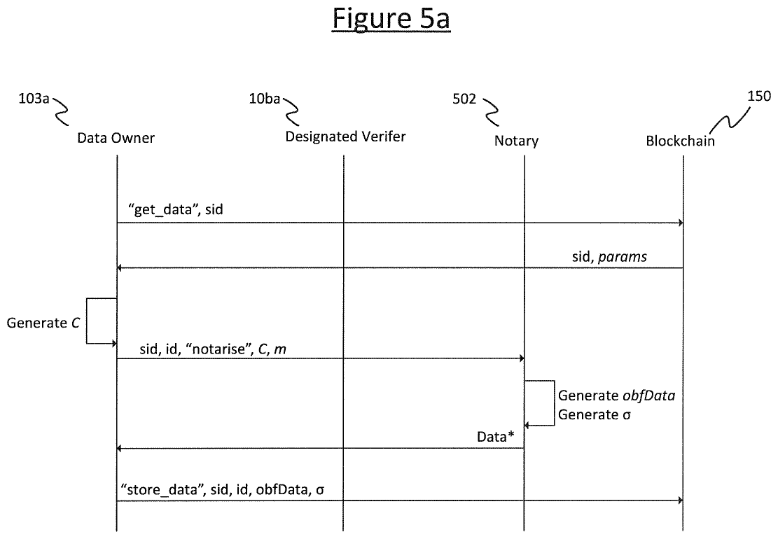

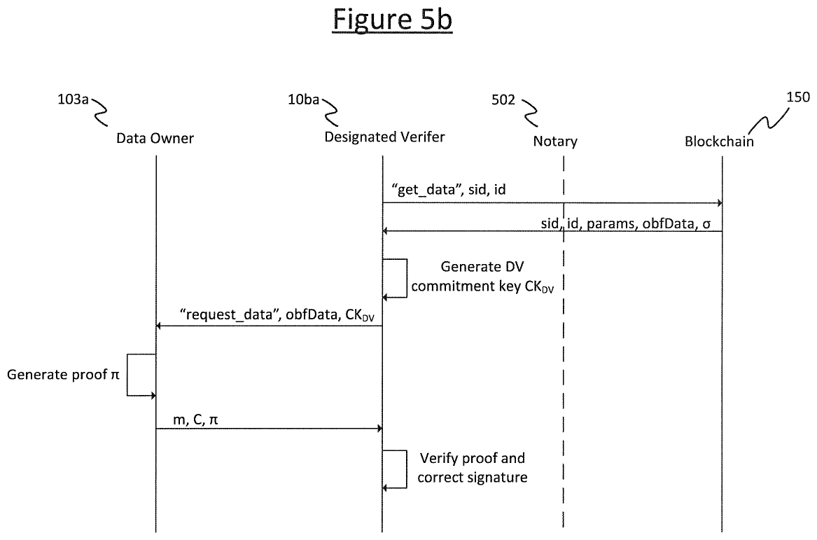

FIGS. 5a and 5b shows the two-phase method set out above.

FIG. 5a shows the notarisation of data phase. The data owner (Alice 103a) sends a request to retrieve the data from the blockchain 150. The request includes a “get_data” command and a scheme ID (sid). The parameters are returned to Alice 103a, which may include the data owner commitment key CK_{DO} if, for example, the key is shared across multiple data owners. If not shared, the data owner does not need to retrieve any data from the blockchain.

Using the retrieved data owner commitment key CK_{DO}, the data m, and the secret value r, Alice 103a generates the data commitment value C.

Alice 103a requests a notary 502 to notarise the data m. To do so, Alice 103a sends to the notary 502 the scheme ID, a data owner ID (id), a “notarise” command, the data commitment value C, and the data m. In response to receiving the request, the notary 502 checks the received data and, provided the data is valid, generates the obfuscation data value by hashing the data commitment value and generates a data signature σ, where σ=Sign(sid|id|obfData; SK). The check performed by the notary 502 may depend on business logic associated with the data, and the data is found to be valid if it complies with the requirements specified by the logic. The notary 502 only signs the data if the commitment value C is a commitment of the data m they have received and checked, and therefore is compliant. Alice 103a proves knowledge of the secret value r in zero-knowledge. The notary 502 executes the verify algorithm set out in section 5.3 to check that Alice 103a does have knowledge of the secret value r.

The notary 502 returns the signed data Data*:=(obfDat,σ) to Alice 103a. Alice 103a generates a blockchain transaction for storing the signed data to the blockchain 150, which also includes the scheme ID and the data owner ID, which she sends to be stored to the blockchain 150 with a “store_data” command.

FIG. 5b shows the Verification of notarised data phase. The designated verifier (Bob 103b) sends a request to retrieve the data from the blockchain 150. The request includes a “get_data” command, the scheme ID, and the data owner ID identifying Alice 103a. The parameters and singed data are returned to Bob 103b, together with the scheme ID and the data owner ID.

Bob 103b generates his commitment key CK_{DV}, which he sends to Alice 103a in a data request together with the obfuscated data value and a “request_data” command.

Based on the received data request, Alice 103a generates the proof T for proving knowledge of the secret value r, which she sends to Bob 103b with the data m and the data commitment value C. Bob 103b implements the Verify algorithm to verify with proof for m and also checks the data signature U. If the proof is verified and the signature is valid, Bob 103b can be assured that the data m is correct and owned by Alice 103a.

The Notary 502 receives the data m so they can enforce compliance of the data before signing. The Notary 502 does not know the private value r, and therefore cannot prove the link between m and C. The Data Owner 103a can prove such a link in zero-knowledge, thus, the Notary 502 acts as a Designated Verifier.

### 8. Data Notarisation as a Service

Unlike in the previous use case described in section 7, the Data Owner trusts the Notary with their private value r. In return, the Notary generates the nizk proof π_{DV} as well as interacts with the blockchain on behalf of the Data Owner. Further, the Notary lets parties register as Designated Verifiers, and prove to them correct notarisation of requested data that is stored in the blockchain. These two services may be offered in exchange of a fee.

In this use case, the Notary performs the Verify algorithm set out in section 5 on behalf of the data owner. This is possible because the data owner trusts the notary with their secret value r.

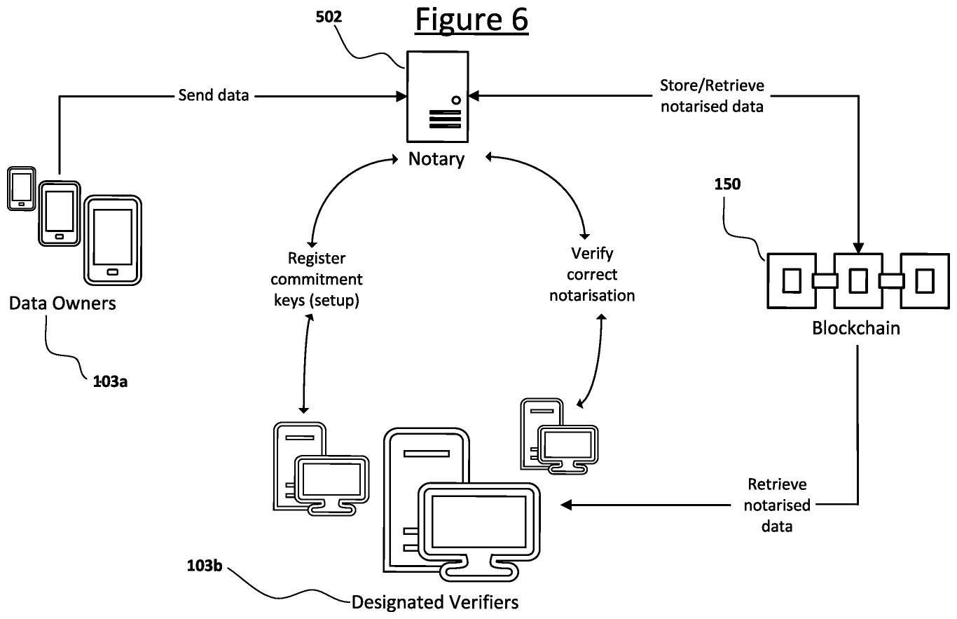

FIG. 6 illustrates the interactions between the parties. The data owner (Alice 103a) sends her data m and secret value r to the notary 502, who checks and notarises (signs) the data. The notary 502 then stores the signed data to the blockchain 150.

The designated verifier (Bob 103b) registers with the notary 502 by sending his commitment key CK_{DV} to the notary 502. When registering, Bob 103b proves to the notary 502 that he knows the trapdoor value x corresponding to his commitment key CK_{DV}. Alternatively, Bob 103b may outsource commitment key generation to a third party that is trusted to reveal the trapdoor value x to the designated verifier. Registration is discussed in more detail below.

When Bob 103b wants to verify data, he retrieves the notarised data from the blockchain 150 and sends it, with a verification request, to the notary 502. The notary 502 also retrieves the notarised data from the blockchain 150 and uses the corresponding secret value r and Bob's commitment key to generate a proof for Bob 103b, implementing the Proof algorithm described above. The proof is provided to Bob 103b so that he can confirm the source of the data by implementing the Verify algorithm.

In this implementation, the Data Owner interacts just once with the Notary 502, only to send their data. After that they remain completely oblivious to the process of notarisation. Namely, uploading obfuscated data to the blockchain (phase 1 of the self-sovereign protocol of section 7), and verification (generating the nizk proof for a designated verifier—phase 2 of section 7).

### 8.1 Signing the Data

The signature put on the data can be done in two ways:

Explicit signature: The Notary 502 signs the data commitment C and sets the obfuscated data to obfDat=SHA256(C∥σ). Thus, the concatenation of the commitment and the signature. It is assumed that the Designated Verifier has the correct Verification Key PK of the notary 502. The Designated Verifier receives the signed commitment, and it checks that the signature is correct and that it hashes to obfDat (which he retrieves from the blockchain).

Implicit signature: The Notary 502 embeds the obfuscated data commitment obfDat as OP_RETURN data of a transaction that spends a P2PKH UTXO. The Designated Verifier receives a P2PKH address that is known to belong to the Notary, the commitment C, and it checks that its hash is embedded in a transaction that spends from Kensei P2PKH address. This has the effect of delegating signature verification to the miners of the blockchain.

### 8.2 Protecting the Notary Against Malicious Verifiers

A coalition of mutually distrusting Designated Verifiers may interact to pay the fee of the Notary just once and re-use the same proof for all of them.

The attack: The malicious verifiers can generate the (trapdoor) commitment key CK_{DV} in a secret-shared way, where each colluded verifier Vᵢ generates an additive share xᵢ ∈ [symbol] ₚ of the trapdoor x and then set CK_{DV}:=(G, H:=x₁·G+ . . . +xₙ·G) without disclosing xᵢ. Since none of the verifiers knows the trapdoor x:=x₁+ . . . +xₙ the same proof π_{DV} would be convincing to all of them.

In such an attack, one of the malicious verifiers could obtain the proof π_{DV} from the notary, and pass the proof on to the other malicious verifiers who would also be convinced of the validity of the underlying data. Therefore, if one of the malicious verifiers is able to convince the notary that they are not malicious, such that the notary provide said malicious verifier with the proof π_{DV}, the verified data can be shared among all of the malicious verifiers.

Notaries can be protected against this type of coalitions of verifiers in two ways.

### 8.2.1 Outsourcing Generation of the Trapdoor

A straightforward solution to avoid malicious coalitions of verifiers is to outsource the generation of the trapdoor commitment key (x, CK_{DV}) to a party, referred to herein as a Trapdoor Generator. This party is trusted to not collude with the Notary to share the trapdoor x, and to not generate simulated proofs. On a generation request from a Designated Verifier, it will issue him a signed pair (x, CK_{DV}). Note it includes the trapdoor x explicitly.

Any party can register a commitment key CK_{DV} with the Notary, who would check such key is signed by the Trapdoor Generator. If that is the case, the Notary is convinced that the knowledge of the trapdoor x of CK_{DV} is known by at least one party—the de facto Designated Verifier—namely the party that requested the generation of the key to the Trapdoor Generator. This would make the proof 7T only convincing for such Designated Verifier (and the Trapdoor Generator) but not the other members of the coalition.

### 8.2.2 Proving Knowledge of the Trapdoor in Zero-Knowledge

The solution set out in section 8.2.1 introduces a new party with a strong degree of trustworthiness, which might not be desirable. Instead, the Designated Verifier can prove (in zero-knowledge) to the Notary that he knows the trapdoor x of a given commitment key CK_{DV}.

The difficulty resides in proving explicit knowledge of the trapdoor x. For example, the standard Schnorr protocol (see Section 4.1.1) to prove knowledge of the logarithm of H in base G does not suffice here. A coalition of verifiers as above can collaborate to prove joint knowledge of x assuming each of them knows an additive share xᵢ only.

### 8.2.2.1 The Underlying Idea

To register the commitment key CK_{DV} with the Notary 502, the Designated Verifier (Bob 103b) plays the role of the prover, and the Notary 502 the role of the verifier. As we shall see later, provided the proof verifies successfully, the verifier is convinced that the prover has used the trapdoor x explicitly in the generation of the proof with overwhelming probability.

The protocol is the standard Schnorr protocol on common input CK_{DV}=(G, H:=x·G) with the following modifications: the verifier issues bit challenges e∈{0,1}, and the prover commits in advance to the two possible answers z₀=a and z₁:=a+x. They commit to zᵢ by hashing it. Thus, it sets cᵢ=Hash(zᵢ) where Hash is a cryptographic hash function (with collision resistance). Here a is a randomness used to generate a first message of the Schnorr protocol. Then, once challenge bit e is revealed, the prover sends zₑ, and the verifier checks that zₑ is a preimage of cₑ.

This modified Schnorr protocol gives soundness error

$$p = \frac{1}{2} .$$

To amplify soundness to p=2^{-s}, the protocol can be repeated s times sequentially.

### 8.2.2.2 Reducing the Number of Repetitions

The size of the challenge can be increased to d bits. Each execution of the protocol with d-bit challenges gives soundness error 2^{-d}. To achieve soundness error 2^{-s}, where s is a fixed security parameter, the protocol is repeated a total of

$$r = \frac{s}{d}$$

times.

Following this, the prover needs to commit to 2^{d} different answers zᵢ:=r+eᵢx. This can be done efficiently using a Merkle tree of depth d, where the i-th leaf is set to zᵢ. The prover sends the root c of the Merkle tree before the verifier issues the challenge e*, and it answers with z*=r+e*x along with the Merkle proof [symbol] for it. The Merkle tree may also be referred to herein as succinct commitments, as it commits to n values, assigned to the leaf nodes, with one element, the Merkle root.

### 8.2.2.3 Security Analysis—why the Prover Knows the Trapdoor Explicitly?

The protocol sketched above has special soundness (see Section 4.1). This means that there exists a polynomial-time extractor algorithm E, that from two different accepting transcripts (with the first message fixed) that can extract the trapdoor x. More specifically, from two different challenges e≠e′ and two answers z, z′, ε extracts by computing

$$x := \frac{z - z′}{e - e′} .$$

Now, assume the prover knows all possible answers. In particular, they can generate two accepting transcripts and run the extractor ε on them to output the trapdoor x. In other words, if the prover knows all possible answers, then they know the trapdoor x explicitly. The probability of not knowing the answers but providing a valid Merkle proof [symbol] for c is at most dϵ, where e is the probability of finding a collision of the hash function used in the Merkle tree of depth d. A convincing prover therefore knows x with probability of at least 1−dϵ. Last, observe that ϵ is negligible in the size of c assuming collision resistance of the hash function used in the Merkle tree.

### 8.2.2.4 Implementing the Protocol in Practice

The non-interactive version (using the Fiat-Shamir transform) of the protocol sketched above may be implemented in the following way:

| Prover: | Verifier: |
|---|---|
| Inputs: | Inputs: |
| • Statement st := CKDV = (G, H) ∈ | • Statement st := CK_{DV} = (G, H) ∈ |
| [symbol] ₚ × [symbol] ₚ | [symbol] ₚ × [symbol] ₚ |
| • Witness: x ∈ [symbol] ₚ s.t. H = x · G | • $Proo \text{f:} π := {( {c}_{i} , {i}_{} , {e}_{i} , {z}_{i} , {n}_{i} )}_{i = 1}^{r} ∈$ |
| • Context information: | ${\{ 0 , 1 \}}^{rk} \times {\{ 0 , 1 \}}^{rdk} \times {ℤ}_{{2}^{d}}^{r} \times {ℤ}_{p}^{r} \times {\{ 0 , 1 \}}^{*}$ |
| • designatedVerifierID ∈ {0,1}* | • Context information: |
| Steps: | designatedVerifierID ∈ {0,1}* |
| 1. π₀ ← (st, designatedVerifierID) | Steps: |
| 2. For i = 1 to r do: | 1. π₀ ← (st, designatedVerifierID) |
| a. aᵢ ← [symbol] ₚ, Aᵢ ← aᵢ · G | 2. For i = 1 to r do: |
| b. For j = 0 to 2^{d} − 1 do: | a. bᵢ ∈ {0,1} ← |
| i. z_{i,j} = aᵢ + jx mod p | CheckMerkleProof (cᵢ, [symbol] ᵢ, zᵢ) |
| c. cᵢ ← | b. If bᵢ = 0, reject and halt |
| GenMerkleRoot (z_{i,0}, ... , z_{i,2}_{^{d}}₋₁) | c. Yᵢ ← eᵢ · H |
| d. (e_{i,} nᵢ) ← | d. Zᵢ ← zᵢ · G |
| GenChallenge (πᵢ₋₁, Aᵢ, cᵢ) // | e. Aᵢ ← Zᵢ − Yᵢ |
| See below | $f . {e}_{i}^{*} ←$ |
| e. zᵢ ← z_{i,e}_{ᵢ} | Trunc (Hash(πᵢ₋₁, Aᵢ, cᵢ, nᵢ) |
| $f . {i}_{} ← GenMerkleProof ( {( {z}_{i , j} )}_{j = 0}^{{2}^{d} - 1} , {e}_{i} )$ | $// Truncate first ⌈ \frac{d}{8} ⌉ bytes$ |
| g. πᵢ ← (Aᵢ, cᵢ, eᵢ, zᵢ) | $g . If {e}_{i}^{*} \neq {e}_{i} reject and halt$ |
| $3. π ← {( {c}_{i} , {i}_{} , {e}_{i} , {z}_{i} , {n}_{i} )}_{i = 1}^{r}$ | h. Else πᵢ ← (Aᵢ, cᵢ, eᵢ, zᵢ) |
| $Outpu \text{t:} π ∈ {\{ 0 , 1 \}}^{rk} \times {\{ 0 , 1 \}}^{rdk} \times {ℤ}_{{2}^{d}}^{r} \times {ℤ}_{p}^{r} \times {\{ 0 , 1 \}}^{*}$ | 3. Accept if no rejections in step 2 |
| GenChallenge(πᵢ₋₁, Aᵢ, cᵢ) | Output: Accept/reject |
| 1. eᵢ ← 2^{d}, nᵢ ← 0 | |
| 2. While eᵢ ≥ 2^{d} do: // Rejection sampling: | |
| a. nᵢ ← nᵢ + 1 | |
| b. hᵢ ← | |
| Hash (πᵢ₋₁, Aᵢ, cᵢ, nᵢ) | |
| $c . {e}_{i} ← Trunc ( {h}_{i} ) // Truncate first ⌈ \frac{d}{8} ⌉ bytes$ | |
| 3. Return (eᵢ, nᵢ) | |

This zero-knowledge proof system proves knowledge of the trapdoor x. It is parameterized with the bitsize d of the challenges and the number of iterations r. The hash function outputs bitstrings of length k.

To preserve zero-knowledge (of the trapdoor), the Prover (the Designated Verifier, Bob 103b) executes all rounds sequentially. This affects how the challenges are derived from the transcript. Specifically, let π₁:=(Rᵢ, cᵢ, eᵢ, zᵢ, [symbol] ) be the transcript generated in the i-th round. The (i+1)-th challenge is the hash of (πᵢ, Rᵢ₊₁, cᵢ₊₁). Also, the prover generates the challenge with e.g., rejection sampling to not introduce bias when reducing mod 2^{d} for arbitrary d.

In this way, Bob 103b proves explicit knowledge of the trapdoor x, and this proves he knowledge of all possible answers for the possible challenges, and commits to them.

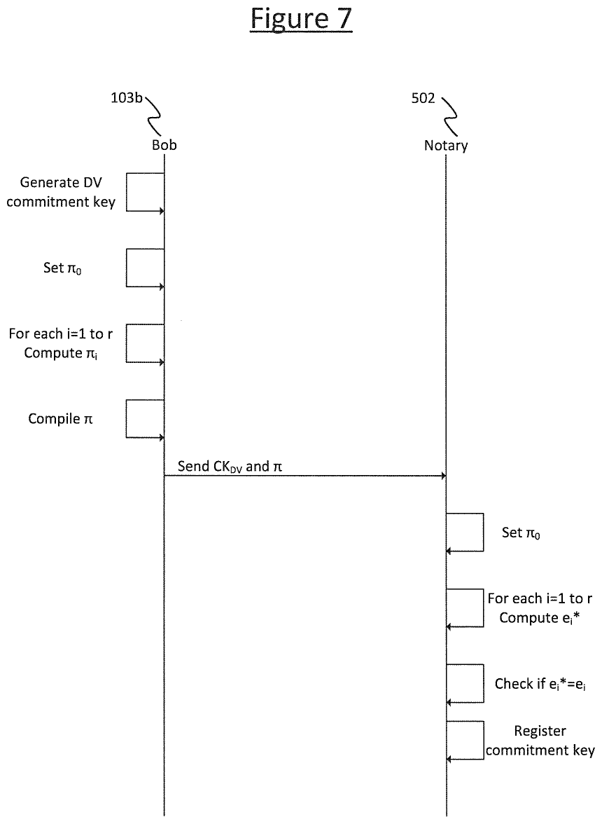

FIG. 7 illustrates the method for registering with the notary 502 as a designated verifier. In the example, Bob 103b is requesting to register with the notary 502.

Bob 103b generates his designated verifier commitment key CK_{DV}, where CK_{DV}=(G, H=x·G).

Bob 103b then implements the prove algorithm set out about. First, he sets π₀ using the context information, which includes the designated verifier commitment key CK_{DV}=(G,H). Then for each 1≤i≤r, Bob 103b computes iteratively πᵢ using πᵢ₋₁. Each πᵢ may be referred to as a challenge proof portion.

To compute each πᵢ, Bob 103b generates a Merkle tree. Bob computes 2^{d} answer values, one for each of j=0 to 2^{d}−1. These values are assigned to the 0^{th} to 2^{d}−1^{th} leaf node of the Merkle tree, such that there are 2^{d} leaf nodes in each Merkle tree associated with answer values.

Using the 2^{d} answer values, Bob 103b generates a Merkle root. Bob 103b uses the Merkle root, a commitment Aᵢ computed using a randomly selected value aᵢ and the first of the commitment key components G, and a previous challenge proof portion πᵢ₋₁, to generate a challenge. The challenge comprises a challenge value eᵢ, also referred to as a target challenge value.

The challenge value eᵢ is used to select one of the answer values. Specifically, the answer value corresponding to j=eᵢ is selected. This selected answer value is used as a preimage for the Merkle proof.

Bob 103b generates the Merkle proof for the selected answer value, that is the authentication path [symbol] that proves inclusion of z_{i,e}_{ᵢ} as a leaf of the Merkle tree whose root is cᵢ, and subsequently generates the challenge proof portion πᵢ. The challenge proof portion comprises the commitment, the Merkle root, the challenge value, and the selected answer value.

Bob 103b generates the proof π comprising each πᵢ for 1≤i≤r together with the Merkle poofs (the authentication paths) [symbol] . That is, based on the r Markle trees he has generated. The challenge proof π comprises the Merkle root, the Merkle proof, the challenge, and the selected answer value.

To improve communication complexity, the commitments Aᵢ from the proof portions πᵢ are removed. Later, the verifier recomputes these values. It will be appreciated that the commitments Aᵢ may be included in the proof π and sent from Prover to Verifier.

Bob 103b provides the proof π and his commitment key CK_{DV} to the notary 502. In a similar way to Bob 103b, the notary 502 sets π₀ using the context information.

For each 1≤i≤r, the notary 502 computes a candidate challenge value

$${e}_{i}^{*}$$

using the proof π provided by Bob 103b, and compares the candidate challenge values to a corresponding target challenge value eᵢ provided in the challenge proof π, also referred to as a target challenge value.

The notary 502 also checks the Merkle proof for each 1≤i≤r provided in the challenge proof π.

If each candidate challenge value matches its corresponding target challenge value, and each of the Merkle proofs is found to be valid, the proof is verified and the notary 502 registers Bob's commitment key CK_{DV}.

Once Bob 103b has registered his commitment key CK_{DV} with the notary 502, Bob 103b can request verification of data by the notary 502 using the proof and verify algorithms set out in section 5.

### 8.2.2.5 Complexity and Choice of Parameters

Pedersen commitments are initiated over any elliptic curve with order p of 256 bits and the hash function used to derive the challenge and to construct the Merkle tree with SHA-256. These choices yield proofs π:=(cᵢ, [symbol] , eᵢ, zᵢ, nᵢ)ᵢ₌₁^{r} of bitsize roughly r(512+257d) where d<<256 is the bitsize of the challenges and r is the number of iterations (rounds).

The prover needs to perform r scalar multiplications and the verifier twice as many. We therefore seek to minimize as much as possible the number of iterations r. This is to minimize both, the computational and communication complexity. However, r cannot be set too small (e.g., r=1), as this would yield a Merkle tree excessively large (e.g., 2^{s} leaves) to compute on Prover's side. There may be, for example, 5, 8, or 16 repetitions (i.e. r=5, 8, 16), however it will be appreciated that the parameters s, d, r are configurable and may be chosen based on the computational power of the designated verifier's device.

Concrete values of r and d should be determined empirically having in mind that

$$r = \frac{s}{d} ,$$

and that we have fixed the soundness security parameter to s∈{80,128,256}.

### 9. Alternatives

In the examples set out above, data m, data commitment value C, and obfuscation data value obfData are retrieved from the blockchain 150. It will be appreciated that some or all of these values may be transferred between the data owner, or the notary in the implementation set out in section 8, and the designated verifier off-chain. This is also the case for the signed data. It will be appreciated that the use of the blockchain for storing and transferring these values introduces an additional level of trust as the values are immutably stored thereon.

The data commitment value in the examples above is C=m·G_{DO}+r·H_{DO}. It will be appreciated that the term data commitment value may be used to reference any other value which requires the user to commit to the data value m. For example, the data commitment value may be a hash (of the data m, of the data commitment value C, or of any other suitable value) or it may be a public key.

### 10. DID and VC

The World Wide Web Consortium (W3C) has provided guidance and standards on Decentralised Identifier (DID) which enables decentralised and verifiable digital identity, and Verifiable Credential (VC) which allows claims, i.e. statements about a subject, to be verified by legitimate verifiers. The W3C Data Model can be accessed at www.w3.org/TR/vc-data-model/.

While DID is decentralised, VC can have trusted entities to issue credentials that can be cryptographically verified. W3C also introduces the idea of verifiable presentation (VP) of a VC, which may allow selective disclosure and other properties to maximise privacy of the VC holder.

A ZKP with Designated verifier can be a VP that cannot be passed on to convince another verifier. As mentioned above, Alice does not want Bob to be able to convince others that she is over 18. Alice can produce a ZKP with the designated verifier being Bob to protect her privacy.

For example, assume that the statement “Alice is over 18” is attested in the form of a public key certificate, i.e., in X509 format. It implies that if Alice can produce a digital signature with respect to the certified public key, then she is over 18. However, instead of producing a valid digital signature which can be reused to convince others, Alice can produce a ZKP of her private key for the designated verifier Bob. As a result, Bob will be convinced that Alice knows the private key without her digital signatures, and Bob cannot convince anyone else.

This approach can be generalised to any verifiable credentials that are cryptographically secured by a secret known to the VC holder.

Another approach is for the VC issuer to certify a commitment to the claims. The holder can present the claims to a designated verifier, who verifies the ZKP proof and issuer's certificate for the commitment.

In the above examples, it will be understood that the VC, here Alice's age or over 18 status, may be considered the data m, where Alice is the VC holder. The challenge proof R is the VP generated for proving to Bob, the designated verifier, that Alice has knowledge of a secret. This secret as a trapdoor may be her private key, and the corresponding certified public key can be the commitment key, for example. In this case, the data m can be implicitly or explicitly attested in the public key certificate by an issuer.

### 11. Further Remarks

Other variants or use cases of the disclosed techniques may become apparent to the person skilled in the art once given the disclosure herein. The scope of the disclosure is not limited by the described embodiments but only by the accompanying claims.

For instance, some embodiments above have been described in terms of a bitcoin network 106, bitcoin blockchain 150 and bitcoin nodes 104. However it will be appreciated that the bitcoin blockchain is one particular example of a blockchain 150 and the above description may apply generally to any blockchain. That is, the present invention is in by no way limited to the bitcoin blockchain. More generally, any reference above to bitcoin network 106, bitcoin blockchain 150 and bitcoin nodes 104 may be replaced with reference to a blockchain network 106, blockchain 150 and blockchain node 104 respectively. The blockchain, blockchain network and/or blockchain nodes may share some or all of the described properties of the bitcoin blockchain 150, bitcoin network 106 and bitcoin nodes 104 as described above.

In preferred embodiments of the invention, the blockchain network 106 is the bitcoin network and bitcoin nodes 104 perform at least all of the described functions of creating, publishing, propagating and storing blocks 151 of the blockchain 150. It is not excluded that there may be other network entities (or network elements) that only perform one or some but not all of these functions. That is, a network entity may perform the function of propagating and/or storing blocks without creating and publishing blocks (recall that these entities are not considered nodes of the preferred bitcoin network 106).

In other embodiments of the invention, the blockchain network 106 may not be the bitcoin network. In these embodiments, it is not excluded that a node may perform at least one or some but not all of the functions of creating, publishing, propagating and storing blocks 151 of the blockchain 150. For instance, on those other blockchain networks a “node” may be used to refer to a network entity that is configured to create and publish blocks 151 but not store and/or propagate those blocks 151 to other nodes.

Even more generally, any reference to the term “bitcoin node” 104 above may be replaced with the term “network entity” or “network element”, wherein such an entity/element is configured to perform some or all of the roles of creating, publishing, propagating and storing blocks. The functions of such a network entity/element may be implemented in hardware in the same way described above with reference to a blockchain node 104.

Some embodiments have been described in terms of the blockchain network implementing a proof-of-work consensus mechanism to secure the underlying blockchain. However proof-of-work is just one type of consensus mechanism and in general embodiments may use any type of suitable consensus mechanism such as, for example, proof-of-stake, delegated proof-of-stake, proof-of-capacity, or proof-of-elapsed time. As a particular example, proof-of-stake uses a randomized process to determine which blockchain node 104 is given the opportunity to produce the next block 151. The chosen node is often referred to as a validator. Blockchain nodes can lock up their tokens for a certain time in order to have the chance of becoming a validator. Generally, the node who locks the biggest stake for the longest period of time has the best chance of becoming the next validator.

It will be appreciated that the above embodiments have been described by way of example only. More generally there may be provided a method, apparatus or program in accordance with any one or more of the following Statements.

Statement 1. A computer-implemented method for proving sole ownership of a commitment key, wherein the commitment key comprises two elements, wherein a secret trapdoor value x defines a relationship between the elements of the commitment key, the method comprising: iteratively computing a challenge proof portion πᵢ for a predefined number of iterations d, wherein the challenge proof portion is generated based on succinct commitments derived using the secret trapdoor value x; generating a challenge proof w based on the challenge proof portions πᵢ; and making the challenge proof π available to a verifier; wherein the challenge proof π is a non-interactive zero-knowledge proof proving knowledge of the secret trapdoor value x.

Statement 2. The method of statement 1, wherein the succinct commitments are represented by a Merkle tree.

Statement 3. The method of statement 2, wherein the method further comprises, for each iteration, deriving the corresponding Merkle tree, wherein at least some leaf nodes of the Merkle tree are assigned an answer value z_{i,j} calculated based on the trapdoor value x and a randomly selected value aᵢ.

Statement 4. The method of statement 3, wherein each answer value is calculated using:

$${z}_{i , j} = {a}_{i} + jx mod p$$

wherein i is the iteration, j is a leaf node number, and p is a soundness error.

Statement 5. The method of any preceding statement, wherein the method further comprises, for each iteration, generating a challenge based on a Merkle root of the Merkle tree and a previous challenge proof portion πᵢ₋₁.

Statement 6. The method of statement 3 and statement 5, wherein the method further comprises selecting one of the answer values based on the generated challenge.

Statement 7. The method of statement 6, wherein the method further comprises generating a Merkle proof based on the selected one of the answer values.

Statement 8. The method of statement 5 and statement 6, wherein the challenge proof portion πᵢ comprises the Merkle root, the selected one of the answer values, and a portion of the challenge.

Statement 9. The method of statement 8, wherein the challenge proof π comprises, for each iteration: the Merkle root; the Merkle proof; the challenge; and the selected answer value.

Statement 10. The method of any preceding statement, wherein each Merkle tree comprises 2^{d} leaf nodes, wherein d is a number of bits of a challenge corresponding to the challenge proof π.

Statement 11. The method of any preceding statement, wherein the challenge proof is made available to the verifier with a request to register the commitment key with the verifier, wherein the verifier is configured to use a registered commitment key to generate a proof of knowledge of a secret value r, wherein the proof of knowledge of the secret value r can only be verified by a user with knowledge of the commitment key.

Statement 12. The method of statement 11, wherein the method further comprises: receiving a target designated verifier commitment value derived based on the secret value r and the commitment key; computing, based on the commitment key, a candidate designated verifier commitment value; and comparing the target designated verifier commitment value to the candidate designated verifier commitment value.

Statement 13. The method of statement 11 or statement 12, wherein the method comprises: obtaining data m; obtaining a data commitment value C computed based on the secret value r and data m; receiving a data challenge solution, wherein the data challenge solution is a non-interactive zero-knowledge proof proving knowledge of the secret value r; and verifying the data commitment value C based on the data m and the data challenge solution.

Statement 14. A method for verifying sole ownership of a commitment key, wherein the commitment key comprises two elements, wherein the relationship between the elements of the commitment key is defined by a trapdoor value x, the method comprising: receiving, from a candidate designated verifier, the commitment key and a challenge proof w, wherein the challenge proof π is derived from a plurality of Merkle trees, wherein the challenge proof comprises for each of the plurality of Merkle trees a Merkle proof and a target challenge value; and for each of a predefined number of iterations, the number of iterations corresponding to a number of Merkle trees from which the challenge proof is derived: checking the Merkle proof corresponding to the Merkle tree; and computing a candidate challenge value and comparing to the target challenge value of the challenge proof T; wherein sole ownership is verified if: the Merkle proof check is passed; and the candidate challenge value is equal to the target challenge value.

Statement 15. The method of statement 14, wherein the method further comprises receiving a request to use the commitment key for generating a proof of knowledge of a secret value r, wherein the proof of knowledge of the secret value r can only be verified by the designated verifier with knowledge of the commitment key, wherein the request is accepted if sole ownership is verified.

Statement 16. The method of statement 14 or statement 15, wherein the step of checking the Merkle proof comprises determining if the Merkle proof corresponds to a Merkle proof preimage, wherein the challenge proof π comprises the Merkle proof preimage for each of the plurality of Merkle trees.

Statement 17. The method of statement 16, wherein the Merkle proof preimage is a selected one of a plurality of answer values zᵢ calculated based on the trapdoor value x and a randomly selected value a.

Statement 18. The method of statement 17, wherein the selected answer value is selected based on the target challenge value.

Statement 19. The method of any of statements 14 to 18, wherein the candidate challenge value is computed based on the received commitment key and challenge proof πc.

Statement 20. The method of any of statements 14 to 19, wherein the challenge proof comprises for each Merkle tree a Merkle root, wherein the Merkle proof check is based on the Merkle proof, the target challenge value, and the Merkle root provided in the challenge proof.

Statement 21. The method of statement 15 or any statement dependent thereon, wherein the method further comprises: generating, based on the commitment key and the secret value r, a designated verifier commitment value; and making the designated verifier commitment value available to the designated verifier.

Statement 22. The method of statement 21, wherein the method further comprises: generating, based on the secret value r and the designated verifier commitment value, a data challenge solution, wherein the data challenge solution is a non-interactive zero-knowledge proof proving knowledge of the secret value r.

Statement 23. Computer equipment comprising: memory comprising one or more memory units; and processing apparatus comprising one or more processing units, wherein the memory stores code arranged to run on the processing apparatus, the code being configured so as to cause the processing apparatus, when run on the processing apparatus, to perform the method of any of statements 1 to 22.

Statement 24. A computer program embodied on computer-readable storage and configured so as, when run on one or more processors, to perform the method of any of statements 1 to 22.

1. A computer-implemented method for proving sole ownership and/or possession of a commitment key, wherein the commitment key comprises two elements, wherein a secret trapdoor value x defines a relationship between the elements of the commitment key, the method comprising:
iteratively computing a challenge proof portion πᵢ for a predefined number of iterations d, wherein the challenge proof portion is generated based on succinct commitments derived using the secret trapdoor value x;
generating a challenge proof π based on the challenge proof portions πᵢ; and
making the challenge proof π available to a verifier;
wherein the challenge proof π is a non-interactive zero-knowledge proof proving knowledge of the secret trapdoor value x.

2. The method of claim 1, wherein the succinct commitments are represented by a Merkle tree.

3. The method of claim 2, wherein the method further comprises, for each iteration, deriving a corresponding Merkle tree, wherein at least some leaf nodes of the Merkle tree are assigned an answer value z_{i,j} calculated based on the trapdoor value x and a randomly selected value aᵢ.

4. The method of claim 3, wherein each answer value is calculated using:
$${z}_{i , j} = {a}_{i} + jx mod p$$
wherein i is the iteration, j is a leaf node number, and p is a soundness error.

5. The method of claim 2, wherein the method further comprises, for each iteration, generating a challenge based on a Merkle root of the Merkle tree and a previous challenge proof portion πᵢ₋₁.

6. The method of claim 3, wherein the method further comprises, for each iteration, generating a challenge based on a Merkle root of the Merkle tree and a previous challenge proof portion πᵢ₋₁, wherein the method further comprises selecting one of the answer values based on the generated challenge.

7. The method of claim 6, wherein the method further comprises generating a Merkle proof based on the selected one of the answer values.

8. The method of claim 6, wherein the challenge proof portion πᵢ comprises the Merkle root, the selected one of the answer values, and a portion of the challenge.

9. The method of claim 8, wherein the challenge proof π comprises, for each iteration:
the Merkle root;
the Merkle proof;
the challenge; and
the selected answer value.

10. (canceled)

11. The method of claim 1, wherein the challenge proof is made available to the verifier with a request to register the commitment key with the verifier, wherein the verifier is configured to use a registered commitment key to generate a proof of knowledge of a secret value r, wherein the proof of knowledge of the secret value r can only be verified by a user with knowledge of the commitment key.

12. The method of claim 11, wherein the method further comprises:
receiving a target designated verifier commitment value derived based on the secret value r and the commitment key;
computing, based on the commitment key, a candidate designated verifier commitment value; and
comparing the target designated verifier commitment value to the candidate designated verifier commitment value.

13. The method of claim 11, wherein the method comprises:
obtaining data m;
obtaining a data commitment value C computed based on the secret value r and data m;
receiving a data challenge solution, wherein the data challenge solution is a non-interactive zero-knowledge proof proving knowledge of the secret value r; and
verifying the data commitment value C based on the data m and the data challenge solution.

14. A method for verifying sole ownership and/or possession of a commitment key, wherein the commitment key comprises two elements, wherein a relationship between the elements of the commitment key is defined by a trapdoor value x, the method comprising:
receiving, from a candidate designated verifier, the commitment key and a challenge proof π, wherein the challenge proof π is derived from a plurality of Merkle trees, wherein the challenge proof comprises for each of the plurality of Merkle trees a Merkle proof and a target challenge value; and
for each of a predefined number of iterations, the number of iterations corresponding to a number of Merkle trees from which the challenge proof is derived:
checking the Merkle proof corresponding to the Merkle tree; and
computing a candidate challenge value and comparing to the target challenge value of the challenge proof π;
wherein sole ownership is verified if:
the Merkle proof check is passed; and
the candidate challenge value is equal to the target challenge value.

15. The method of claim 14, wherein the method further comprises receiving a request to use the commitment key for generating a proof of knowledge of a secret value r, wherein the proof of knowledge of the secret value r can only be verified by the designated verifier with knowledge of the commitment key, wherein the request is accepted if sole ownership is verified.

16. The method of claim 14, wherein the step of checking the Merkle proof comprises determining if the Merkle proof corresponds to a Merkle proof preimage, wherein the challenge proof π comprises the Merkle proof preimage for each of the plurality of Merkle trees.

17-18. (canceled)

19. The method of claim 14, wherein the candidate challenge value is computed based on the received commitment key and challenge proof π.

20. The method of claim 14, wherein the challenge proof comprises for each Merkle tree a Merkle root, wherein the Merkle proof check is based on the Merkle proof, the target challenge value, and the Merkle root provided in the challenge proof.

21. The method of claim 15, wherein the method further comprises:
generating, based on the commitment key and the secret value r, a designated verifier commitment value; and
making the designated verifier commitment value available to the designated verifier.

22. The method of claim 21, wherein the method further comprises:
generating, based on the secret value r and the designated verifier commitment value, a data challenge solution, wherein the data challenge solution is a non-interactive zero-knowledge proof proving knowledge of the secret value r.

23. (canceled)

24. A computer program embodied on non-transitory computer-readable storage media and configured so as, when run on one or more processors, to perform a method for proving sole ownership and/or possession of a commitment key, wherein the commitment key comprises two elements, wherein a secret trapdoor value x defines a relationship between the elements of the commitment key, the method comprising:
iteratively computing a challenge proof portion πᵢ for a predefined number of iterations d, wherein the challenge proof portion is generated based on succinct commitments derived using the secret trapdoor value x;
generating a challenge proof π based on the challenge proof portions πᵢ; and
making the challenge proof π available to a verifier;
wherein the challenge proof π is a non-interactive zero-knowledge proof proving knowledge of the secret trapdoor value x.
